(19) United States
(12) Patent Application Publication
(10) Pub. No.: US 2020/0284636 A1
(43) Pub. Date: Sep. 10, 2020

(54) RECIPROCATING FLUID METER

(71) Applicant: Quanta IQ, Inc., Irvine, CA (US)

(72) Inventor: William Clark Cronin, Irvine, CA (US)

(21) Appl. No.: 16/294,828

(22) Filed: Mar. 6, 2019

(51) Int. Cl. G01F 3/16

(52) U.S. Cl. CPC G01F 3/16

(57) ABSTRACT

A reciprocating fluid meter assembly comprises a cylinder housing with two internal chambers separated by a piston. The piston is coupled with a pushrod that reciprocates back and forth between two positions. The piston's position is tracked to measure the volume of fluid passing through the meter. The meter has two inlets, two outlets, two inlet passages, and two outlet passages. A first valve is positioned on the pushrod at a junction between the first inlet passage and first outlet passage. A second valve is positioned on the pushrod at a junction between the second inlet passage and second outlet passage. The pushrod can be positioned in a neutral position to simultaneously close both valves. In some embodiments, the valves comprise a perforated spindle. The meter can also include a driving mechanism, such as an air cylinder or electric motor, for controlling the position of the pushrod.

### FIELD OF INVENTION

The field of the invention is flow meters.

### BACKGROUND

The following description includes information that may be useful in understanding the present invention. It is not an admission that any of the information provided herein is prior art or relevant to the presently claimed invention, or that any publication specifically or implicitly referenced is prior art.

Currently the flow control and metering industries are limited in their ability to accurately measure and concurrently control rates of flow across a broad spectrum with a single device. Consequently, the rate of flow in which the customer must operate any given meter, must be inside of a given rate of flow envelope (as published by the manufacturer) in order to receive accurate rate, velocity and volume information. This operating envelope can be narrow. This restriction can hinder the customer in choosing the appropriate metering device for a given application, as quite often the rate of flow will exit this accuracy envelope, be it on the low or high side.

When a manufacturer of a metering device publishes operating statistics for their product, the term “turndown ratio” or “rangeability” is always very high on the list of questions asked by a potential buyer. Turndown ratio is the maximum rate of flow, divided by the minimum rate of flow put forward by the manufacturer. If the rate of flow exits this given range, the accuracy of the meter will degrade sharply, this is the operating envelope referred to in the previous paragraph. For example, if a meter has a published turndown ratio of 50 (or 50:1), it would mean that the meter would be capable of accurately measuring down to 1/50^{th} of its maximum operating range. Given this example, a meter with a turndown ratio of 50, with a maximum range of 20 GPM, will accurately measure down to 0.4 GPM. Flow exceeding this high/low range will not be measured or recorded with a high degree of accuracy.

Predominantly we see turndown ratios of 50 or less available in today's market place. To combat this, some manufacturers will pair mechanical meters of different capabilities together to create a new metering product. The meters which make up this new product will have a high rate of flow envelope, say 10 to 200 GPM, and the other, a low flow envelope, 0.5 to 15 GPM. The manufacturer of this meter can now measure across a broader range, expanding the accuracy envelope to the highest and lowest ranges of each meter, in this example 0.5 GPM to 200 GPM, giving it a turndown ratio of 400. This is called a compound meter.

Previous versions of piston/cylinder meters do exist, but all have faults which detract from their accuracy, throughput and reliability. For example, U.S. Pat. No. 3,459,041 to Hippen describes a complex metering device that lacks a timing mechanism, along with an external valve. These drawbacks hindered the meter in 3 ways. First the lack of a timing mechanism eliminated its ability to measure rate of flow (the device only measures total volume). Second, it cannot start and stop flow in conjunction with user input. And last, its reliability was hindered by a large number of moving parts.

The Hippen invention was designed to address two problems associated with a piston/cylinder metering device. These problems were the inability to detect very low rates of flow (this resulted in fluid passing previous piston/cylinder meters undetected), and backpressure created by two or more valves being closed inside of the device simultaneously. While the Hippen patent aimed to solve these issues, there were in fact additional problems associated with a piston/cylinder metering device which were not addressed by the Hippen patent.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems and methods in which A reciprocating piston fluid meter assembly comprises a cylinder housing (ref FIG. 1a, 150) separated by a piston (ref FIG. 2a, 260) into two chambers (ref FIG. 5b. 525, 528) and measures the flow rate and volume of a fluid by tracking the distance traveled by the piston along a pushrod (210) running through a cylinder. It is contemplated that the reciprocating piston fluid meter can be used to measure the flow rate of any fluid, including gas, liquid (including water, solution, and oil), and any mixture thereof.

In preferred embodiments, the reciprocating piston fluid meter assembly has two inlets (ref FIG. 2a-2b, 310, 320), two outlets (330, 340), two end-caps (300L, 300R), and four passages each coupling one inlet or outlet to a chamber. A perforated spindle valve (230L, 230R) at each end of the pushrod (210) is positioned at a junction between two passages inside of each endcap (300L, 300R), and can simultaneously control the two passages by shutting them both or allowing only one in each endcap to be open. Since fluid cannot pass through the system without triggering the travel of piston 260, which is tracked by a tracking device (e.g., linear encoder), the reciprocating fluid meter is highly sensitive and can detect very small flow volumes and velocities.

The pushrod (210) comprises an elongated member that travels inside the cylinder housing (150). In preferred embodiments, spring catches (FIG. 3a-b, 235L, 235R) are rigidly coupled to pushrod 210, along with rigidly coupled perforated spindle valves 230L and 230R, and engaging elements 220L and 220R. Two sealing members (FIG. 5,6a-e, 400L, 400R) are disposed outside of endcaps 300L and 300R. Each have magnets (FIG. 6c-d, 420L, 420R) that interact with the engaging elements (220L, 220R), which provides magnetic force sufficient to counteract the elastic force created by springs 250L and 250R (FIG. 3a).

The reciprocating fluid meter assembly has one or more mechanisms to provide damping force that at least partially reduces the travel speed of pushrod assembly 200 (FIG. 3b). First, the sealing members (FIG. 7a-b, 400L, 400R) contain damping pins (410L, 410R) which can be transitioned inside bores (FIG. 7a, 211R) on either end of the pushrod (210). Second, pushrod 210 has bores (211L, 211R) with a thru-hole (212L, 212R) through a longitudinal wall of the pushrod. Third, the sealing members (400L, 400R) have receptacles that can interact with engaging elements 220L and 220R. Third, the engaging elements (220L, 220R) have through holes (FIG. 3b, FIG. 7b-c, 221-226) that can be either open or blocked by screws (e.g., FIG. 7a-c, 466L, 466R). It is contemplated that one or more sources of damping force can be adjusted, and one or more elements described above have tapered or non-tapered walls. It is also contemplated that one or more O-rings can be used to seal one or more holes or receptacles.

Because the reciprocating piston fluid meter (e.g. RPM, reciprocating piston meter, or reciprocating fluid meter) relies on the positive displacement of piston 260 to measure flow, it enables the system to detect and measure flow rates which other meters are not capable of detecting, this is especially true at very low rates and velocities. Because the position of the piston (in conjunction with time) is used to calculate rate, it allows the invention to hold accuracy across a very large range, and allows the system to produce repeatable volume/mass accuracies which rival Coriolis meters at 0.05 to 0.1%.

In some embodiments, the RPM can be configured to measure flow rates from 0.0004 GPM to 60.0 GPM, giving it a turndown ratio of 150,000.

Such embodiments can also be configured to measure flow velocities as low as 0.0001 FPS up to 25 FPS.

Various meter configurations can be constructed to target the specific high or low ranges required by the customer's application. For example, high flow velocity or rate applications will require a larger cylinder diameter (FIG. 150), in which case the meters high end may be 250 GPM, but the resolution will diminish in accordance with the larger tube diameter.

The RPM can detect flow rates as small as 5 ml over a 60-minute time period. In other embodiments, it can be stated that a variety of applications would benefit from a smaller tube diameter. As such, the resolution of the invention increases, making the device more accurate, but decreasing the maximum rate/velocity of flow, through the device. Applications which may benefit from a smaller tube diameter may include laboratory environments in the petrochemical, pharmaceutical and food industries.

The high turndown ratio, in combination with the inventions accuracy, will provide the end user with a metering solution which could be beneficial in flow control, batching, dosing, compounding, custody transfer and leak detection operations.

The RPM solves a multitude of problems not only seen in the Hippen device, but in other previous piston/cylinder metering devices. These problems appear in 4 categories:

1) Rate of Flow—The Hippen invention, and previous inventions, could only record the total volume which passed through them. They did not record/report rate of flow, as the devices could not measure time in accordance with flow. Ex: If 5 gallons passed through the meter in 1 minute, the Hippen device would only display 5 gallons, not the rate of 5 gallons per minute, as it did not contain an internal clock.

2) External Valve—The Hippen invention cannot start or stop flow in conjunction with programmed user input, as it does not have an external valve. Ex: The RPM can be used for batching/dosing (filling multiple containers repeatedly with an identical quantity of fluid). Custody transfer (the transfer of a specific amount of fluid for purchase), compounding (making another product using an exact fluid volume) and leak detection (the valve allows the RPM to shutoff all flow, should a leak be detected.

3) Accuracy
The RPM can precisely track piston position through the use of a linear encoder.
The solid pushrod ensures that the valves inside of either endcap switch at exactly the same time, in perfect unison with one and other. The use of a solid pushrod, as opposed to a pushrod which actuates individual spring-loaded valves through a lever, as the Hippen device does, eliminates numerous parts, and makes the device significantly more reliable.

4) Simplicity of Build
Magnet—The RPM uses a magnet to oppose the energy created by the piston compressing the pushrod spring. Once the spring is fully compressed, the magnet is forced to release the pushrod, allowing the compressed spring to thrust the valve to its new position, engaging the magnet on the opposite side, and reversing flow. This action reverses the pistons direction. This simple action eliminates numerous parts, making the device reliable and simple.
Piston Tracking—The RPM tracks the position of the piston by embedding a magnet inside of the piston and tracking the position of the piston through the movement of another magnet which sits outside of the cylinder (directly on top of the piston magnet). When the piston moves, the external magnet which sits outside of the cylinder moves with it.
Linear Encoder—The RPM uses a linear encoder in conjunction with magnets embedded in the piston to measure the position of the piston along its longitudinal track. This allows us to report and record the position of the piston.
Internal Valve Simplicity—The RPM uses a more efficient valve configuration. This is achieved by allowing fluid to flow through the same channel, in either direction (these channels begin at the six large holes inside the fluid chambers in the cylinder and run through each endcap to the center of the valve). The device can change direction of flow through the valves in either endcap, in unison, by moving the solid pushrod assembly a short distance when the piston reaches its full range of travel, reversing the direction of the piston.

Various objects, features, aspects and advantages of the inventive subject matter will become more apparent from the following detailed description of preferred embodiments, along with the accompanying drawing figures in which like numerals represent like components.

### Alternate Embodiment (A) FIG. 1d

In alternate embodiment (A), the power needed to drive pushrod assembly 750 (FIG. 3k) is provided by an air cylinder or electric motor 712 (FIG. 1d). The air cylinder or electric motor 712 has a shaft that is rigidly attached to pushrod 706. The air cylinder/electric motor 712 has a body that is rigidly attached through stand-offs (FIG. 1d, 3e, 712) to right sealing member 700R (FIG. 1d). Perforated spindle valves 702R and 702L are also rigidly attached to pushrod 706 (FIG. 2c, 3k).

Alternate embodiment (A) simplifies the primary embodiment by both eliminating the spring/magnet drive mechanism, and making the remaining parts less complex.

The following parts are eliminated from the primary spring/magnet embodiment: Engaging elements 220L and 220R, spring catches 235L and 235R, springs 250L and 250R, damping pins 410L and 410R and magnets 420L and 420R (Reference FIGS. 2a, 2b and 3a).

The following parts are unique to the primary embodiment: Piston 260, perforated spindle valve 230L and 230R, pushrod guide 240L and 240R, pushrod 210 (Reference FIGS. 2a, 2b and 3a).

The following parts are unique to alternate embodiment (A): Piston 710, perforated spindle valve 702L and 702R, pushrod guide 704L and 704R and pushrod 706 (Reference FIG. 2c).

### Alternate Embodiment (B) RPM Pump FIG. 1e

Alternate embodiment (B) is a highly accurate, positive displacement piston pump. It combines the accuracy of the primary embodiment and alternate embodiment (A) with a linear actuator that can precisely control rate of flow. Alternate embodiment (B) is a standalone piston pump, and can start, stop or alter flow rates based on input from the user through the interface.

Alternate embodiment (B) FIG. 1e depicts a subassembly framework which is built in conjunction with the primary embodiment (FIG. 1a), or alternate embodiment (A) (FIG. 1d). This framework, which incorporates a stepper motor and linear actuator, allows piston 846, FIG. 2f, 2h to be precisely moved back and forth along the same track as the primary or alternate embodiment (A).

### BRIEF DESCRIPTION OF DRAWINGS

FIG. 1a is a front, left, top perspective view of an embodiment of A reciprocating fluid meter.

FIG. 1b is a front, right, top perspective view of the reciprocating fluid meter of FIG. 1a.

FIG. 1c is a rear, right, top perspective view of the reciprocating fluid meter of FIG. 1a.

FIG. 1d is a front, right, top perspective view of an alternate embodiment (A) of the reciprocating fluid meter of FIG. 1d.

FIG. 1e is a front, right, top perspective view of an alternate embodiment (B).

FIG. 2a is an exploded perspective view of the reciprocating fluid meter of FIG. 1a, without the display.

FIG. 2b is an exploded top plan view of the reciprocating fluid meter of FIG. 1a, without the display.

FIG. 2c is an exploded perspective view of the alternate embodiment (A) of the reciprocating fluid meter of FIG. 1d.

FIG. 2d is a front, right, top perspective view of the alternate embodiment (B) of the reciprocating fluid meter of FIG. 1a.

FIG. 2e is a front, right, top perspective view of the alternate embodiment (B) of the reciprocating fluid meter of FIG. 1d.

FIG. 2f is a front, right, top cutaway view of the alternate embodiment (B) of the reciprocating fluid meter of FIG. 1a.

FIG. 2g is a front, right, top cutaway/exploded view of the alternate embodiment (B) of the reciprocating fluid meter of FIG. 1a.

FIG. 2h is a front, right, top cutaway view of the alternate embodiment (B) of the reciprocating fluid meter of FIG. 1d.

FIG. 2I is a front, right, top cutaway exploded view of the alternate embodiment (B) of the reciprocating fluid meter of FIG. 1d.

FIG. 3a is an exploded view of pushrod assembly 200 and related components in the reciprocating fluid meter of FIG. 1a.

FIG. 3b is a perspective view of pushrod 210, engaging elements 220L, 220R, perforated spindle valves 230L, 230R, spring catches 235L, 235R, and pushrod guide 240L, 240R in the reciprocating fluid meter 001 of FIG. 1a.

FIG. 3c is a vertical cross-sectional view (along line A-A in FIG. 3b) of the pushrod, engaging elements, perforated spindle valves, spring catches and pushrod guides in the reciprocating fluid meter 001 of FIG. 1a.

FIG. 3d is a horizontal cross-sectional view (along line B-B in FIG. 3b) of the pushrod, engaging elements, perforated spindle valves, spring catches and pushrod guides in the reciprocating fluid meter 001 of FIG. 1a.

FIG. 3e is a perspective view of alternate embodiment (A) pushrod assembly and power source. It includes pushrod 706, perforated spindle valves 702L and 702R, pushrod guides 704L and 704R, sealing members 700L and 700R, standoffs 714, the air cylinder/motor mounting block 708 and the 3 position air cylinder/motor part 712.

FIG. 3f is a horizontal cross-sectional view (along line B-B in FIG. 3b) of alternate embodiment (A) pushrod assembly. The parts consist of pushrod 706, perforated spindle valves 702L and 702R, pushrod guides 704L and 704R, sealing members 700L and 700R, along with the 3 position air cylinder/motor part 712.

FIG. 3g is a left side view of endcap 300R, depicting pushrod guide 240R disengaged from endcap 300R, with fasteners 237, 238 and 239 also disengaged.

FIG. 3h is a left side view of endcap 300R, depicting pushrod guide 240R fully seated and affixed in place by fasteners 237, 238 and 239.

FIG. 3i is a left side view of endcap 300R, depicting pushrod guide 704R fully seated and affixed in place by fasteners 237, 238 and 239.

FIG. 3j is a perspective cross-sectional view of alternate embodiment (A) of FIG. 1d. FIG. 3j depicts pushrod assembly 750 (Ref. FIG. 3k) in a second position.

FIG. 3k is a perspective view of alternate embodiment (A) pushrod assembly.

FIG. 4a is a multi-angle sectional view of an end-cap (300) in the reciprocating fluid meter of FIG. 1a.

FIG. 4b is a left side view of the right end-cap in the reciprocating fluid meter of FIG. 1a.

FIG. 5a is a perspective cross-sectional view of the reciprocating fluid meter of FIG. 1a, along line A-A of the right end-cap in FIG. 4b showing two of six channels (302L, 302R and 305L, 305R) in each end-cap.

FIG. 5b is a side cross-sectional view of the reciprocating fluid meter of FIG. 1a, along line A-A of the right end-cap in FIG. 4b showing two of six channels in each end-cap.

FIG. 5c is a perspective view of a cross section of the reciprocating fluid meter of FIG. 1a, along line B-B of the right end-cap showing two of six channels (301L, 301R and 306L, 306R) in each end-cap.

FIG. 5d is a side cross-sectional view of the reciprocating fluid meter of FIG. 1a, along line B-B of the right end-cap showing two of six channels in each end-cap.

FIG. 5e is a perspective cross-sectional view of the reciprocating fluid meter 001 of FIG. 1a, along line D-C (in FIG. 4b) of the right end-cap and line C-D (in FIG. 4b) of the left side, showing a portion of the first and third passages. (Note the orientation of FIG. 4b differs from the orientation of FIG. 5e)

FIG. 5f is a side cross-sectional view of the reciprocating fluid meter of FIG. 1a, along line C-D (in FIG. 4b) of the left end-cap, showing a portion of the first and third passages, and along line D-C (in FIG. 4b) of the right end-cap showing a portion of second and fourth passages. (Note the orientation of FIG. 4b differs from the orientation of FIG. 5e).

FIG. 5g is a perspective cross-sectional view of alternate embodiment (A) of 002 FIG. 1d, along line D-C (in FIG. 4b) of the right end-cap and line C-D (in FIG. 4b) of the left side, showing a portion of the first and third passages.

FIG. 5h is a side cross-sectional view of alternate embodiment (A) of 002 FIG. 1d, along line B-B of the right end-cap showing two of six channels in each end-cap (ref FIG. 4b).

FIG. 6a is an outside perspective view of the right sealing member (400R) in the reciprocating fluid meter of FIG. 1a.

FIG. 6b is an inside perspective view of the right sealing member in the reciprocating fluid meter of FIG. 1a.

FIG. 6c is a vertical cross-sectional view of the right sealing member along line A-A in FIG. 6b.

FIG. 6d is a vertical cross-sectional view of the sealing member along line B-B in FIG. 6c.

FIG. 6e is a vertical cross-sectional view of the sealing member along line C-C in FIG. 6c.

FIG. 6f is a perspective view and cross-sectional views along lines D-D and E-E of the right sealing member in the reciprocating fluid meter of FIG. 1a.

FIG. 6g is a cross-sectional side view (along line D-D in FIG. 6f) of the sealing member in FIG. 6f.

FIG. 6h is a cross-sectional side view (along line E-E in FIG. 6f) of the sealing member in FIG. 6f.

FIG. 7a is a side cross-sectional view of the right sealing member interacting with the pushrod in the reciprocating fluid meter of FIG. 1a.

FIG. 7b is a perspective cross-sectional view of the right sealing member interacting with the pushrod in the reciprocating fluid meter of FIG. 1a.

FIG. 7c is an exploded view of the right sealing member in the reciprocating fluid meter of FIG. 1a.

FIG. 8a is an exploded view of the encoder housing in the reciprocating fluid meter of FIG. 1a.

FIG. 8b is an exploded perspective view of the encoder alignment with the piston in the reciprocating fluid meter of FIG. 1a.

FIG. 8c is a cross-sectional view of the encoder alignment magnets (263, 264) with the piston and piston encoder magnets (261, 262) in the reciprocating fluid meter of FIG. 1a.

FIG. 9a is a partially exploded cross-sectional view of the left end-cap and sealing member in the reciprocating fluid meter of FIG. 1a, with the engaging element (220L) disengaged from sealing member 400L.

FIG. 9b is a partially exploded cross-sectional view of the left end-cap and sealing member in the reciprocating fluid meter of FIG. 1a, with the engaging element (220L) partially entering sealing member (400L), half-way across its total travel length.

FIG. 9c is a partially exploded cross-sectional view of the left end-cap and sealing member in the reciprocating fluid meter of FIG. 1a, with the engaging element (220L) completely engaged with the sealing member (400L).

FIG. 9d is a partially exploded cross-sectional view of right end-cap 300R in alternate embodiment (A) of reciprocating fluid meter 002 of FIG. 1d. Note position of perforated spindle valve 702R in a third position, allowing fluid to exit the device, while entering the device from the opposite side.

FIG. 9e is a partially exploded cross-sectional view of right end-cap 300R in alternate embodiment (A) of reciprocating fluid meter 002 of FIG. 1d. Note position of perforated spindle valve 702R in a center second position, closing both inlet port 310, and outlet port 330.

FIG. 9f is a partially exploded cross-sectional view of right end-cap 300R in alternate embodiment (A) of reciprocating fluid meter 002 of FIG. 1d. Note position of perforated spindle valve 702R in a first position, allowing fluid to enter the device, while exiting the device from the opposite side.

FIG. 10a is a cross-sectional view of the reciprocating fluid meter of FIG. 1a, along line C-C in FIG. 4b, showing the pushrod assembly (200) in a first position where the first passage (310) (between first inlet and first chamber 528) is open, the second passage (320) (between second inlet and second chamber 525) is closed, the third passage (330) (between first chamber 528 and first outlet) is closed, the fourth passage (340) (between second chamber 525 and second outlet) is open.

FIG. 10b is a cross-sectional view of the reciprocating fluid meter of FIG. 1a, along line C-C in FIG. 4b, showing the pushrod assembly (200) in the first position as in FIG. 10a, where the piston (260) has traveled further to the left side and spring 250L has made contact with spring catch 235L on the left side.

FIG. 10c is a cross-sectional view of the reciprocating fluid meter of FIG. 1a, along line C-C in FIG. 4b, showing the pushrod assembly (200) in the first position as in FIG. 10, spring 250L is fully compressed between piston 260 and spring catch 235L, and piston 260 has made contact with catch 235L at point 241 (point 241 is the face of the piston and the face of spring catch 235L, see FIG. 3c, 245L, 245R and FIG. 9a).

FIG. 10d is a cross-sectional view of the reciprocating fluid meter of FIG. 1a, along line C-C in FIG. 4b, showing the pushrod assembly (200) in a second position, where the first passage (310) (between first inlet and first chamber 528) is closed, the second passage (320) (between second inlet and second chamber 525) is closed, the third passage (330) (between first chamber 528 and first outlet) is closed, the fourth passage (340) (between second chamber 525 and second outlet) is closed.

FIG. 10e is a cross-sectional view of the reciprocating fluid meter of FIG. 1a, along line C-C in FIG. 4b, showing the pushrod assembly (200) in a third position, where the first passage (310) (between first inlet and first chamber 528) is closed, the second passage (320) (between second inlet and second chamber 525) is open, the third passage (330) (between first chamber 528 and first outlet) is open, the fourth passage (340) (between second chamber 525 and second outlet) is closed. Engaging element 220L is seated against surface 453L (FIG. 6c), adjacent to magnet 420L, and the piston has reversed direction.

FIG. 10f is a cross-sectional view of the reciprocating fluid meter of FIG. 1a, along line C-C in FIG. 4b, showing the pushrod assembly (200) in the third position as in FIG. 10e, showing the piston is disposed just left of the center position and is moving towards the right.

FIG. 10g is a cross-sectional view of the reciprocating fluid meter of FIG. 1a, along line C-C in FIG. 4b, showing the pushrod assembly (200) in the third position as in FIG. 10e, showing the piston is disposed right of center and spring 250R is in contact with spring catch 235R.

FIG. 10h is a cross-sectional view of alternate embodiment (A) reciprocating fluid meter of FIG. 1d. Along line C-C in FIG. 4b, showing the pushrod assembly (750 FIG. 3k) in a first position where the first passage (310) (between first inlet and first chamber 528) is open, the second passage (320) (between second inlet and second chamber 525) is closed, the third passage (330) (between first chamber 528 and first outlet) is closed, the fourth passage (340) (between second chamber 525 and second outlet) is open.

FIG. 10i is a cross-sectional view of alternate embodiment (A) reciprocating fluid meter of FIG. 1d, Along line C-C in FIG. 4b, showing the pushrod assembly (750 FIG. 3k.) in a second position, where the first passage (310) (between first inlet and first chamber 528) is closed, the second passage (320) (between second inlet and second chamber 525) is closed, the third passage (330) (between first chamber 528 and first outlet) is closed, the fourth passage (340) (between second chamber 525 and second outlet) is closed.

FIG. 10j is a cross-sectional view of alternate embodiment (A) reciprocating fluid meter of FIG. 1d, Along line C-C in FIG. 4b, showing the pushrod assembly (750 FIG. 3k) in a third position, where the first passage (310) (between first inlet and first chamber 528) is closed, the second passage (320) (between second inlet and second chamber 525) is open, the third passage (330) (between first chamber 528 and first outlet) is open, the fourth passage (340) (between second chamber 525 and second outlet) is closed, and the piston has reversed direction.

### DETAILED DESCRIPTION

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless specified otherwise, the left side of the reciprocating fluid meter is symmetrical to its right side. The letter “R” designates the on the right side; the letter “L” designates the left side.

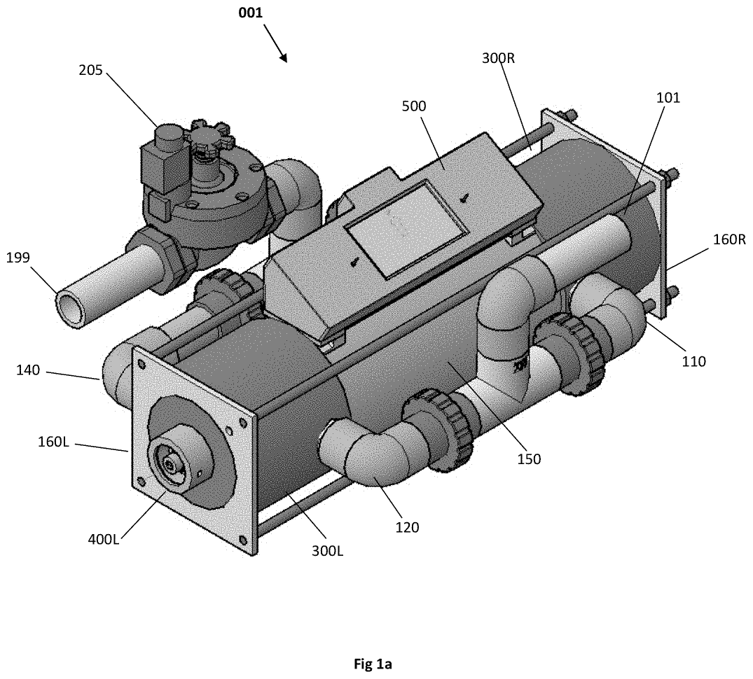

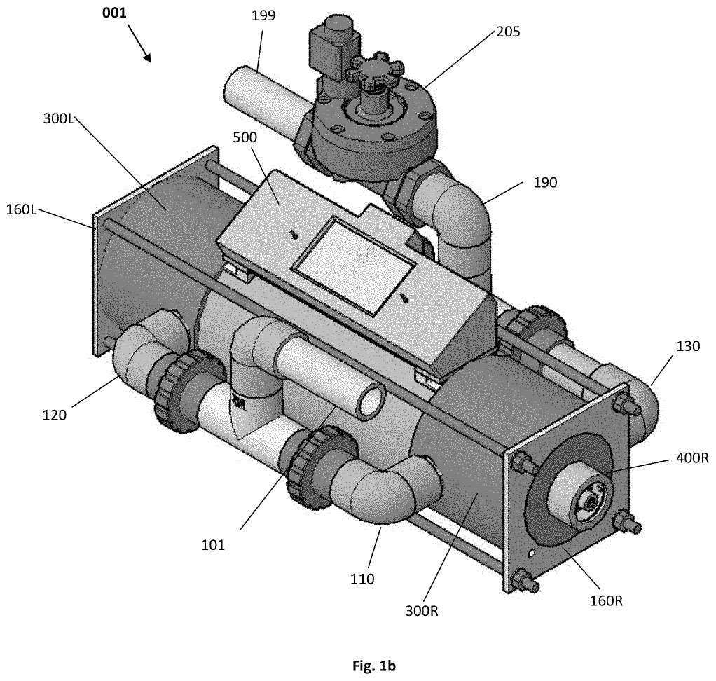

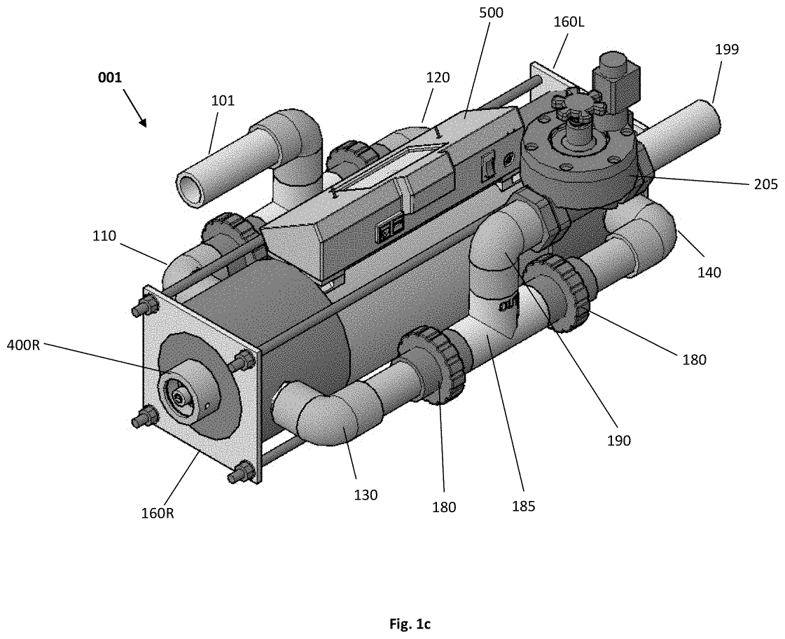

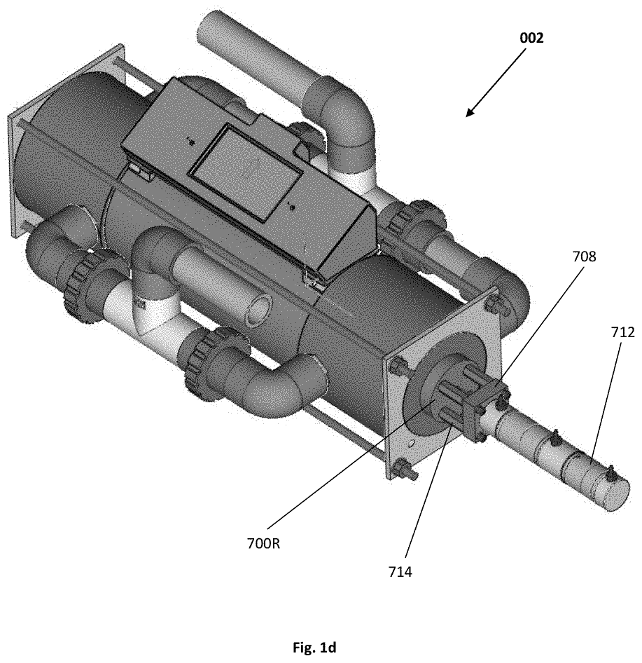

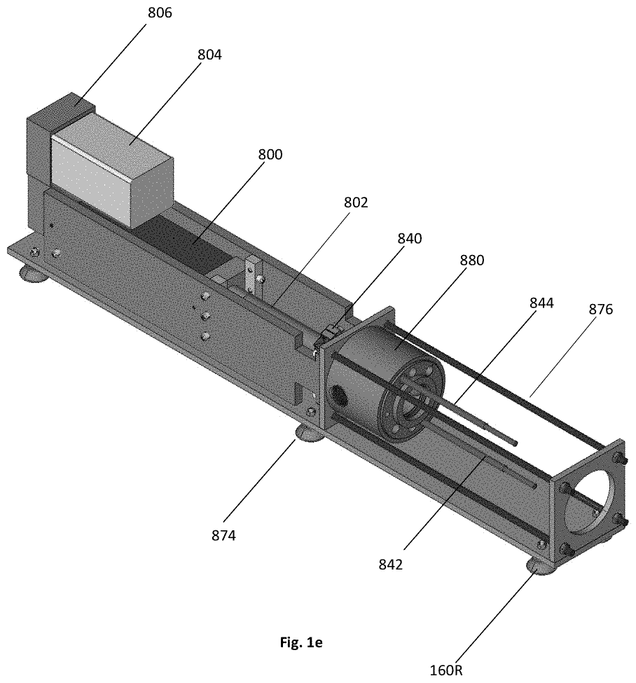

FIGS. 1a-c show an embodiment of a reciprocating fluid meter 001. FIG. 1a is a front, left, top perspective view of an embodiment of a reciprocating fluid meter 001. FIG. 1b is a front, right, top perspective view of the reciprocating fluid meter 001 of FIG. 1a. FIG. 1c is a rear, right, top perspective view of the reciprocating fluid meter 001 of FIG. 1a.

FIG. 1d shows alternate embodiment (A) of a reciprocating fluid meter 001. FIG. 1d is a front, right, top perspective view of the alternate embodiment (A) of a reciprocating fluid meter 002.

FIG. 1e shows alternate embodiment (B). It is a front, right, top perspective view of alternate embodiment (B).

The reciprocating fluid meter 001 and alternate embodiment (A) 002 in FIG. 1a, 1d has a housing 150, two end-caps (ref FIGS. 1a-1d) 300L and 300R, two sealing members 400L, 400R, and 700L, 700R in alternate embodiment (A), a display/computer housing 500, a main inlet 101, and a main outlet 199.

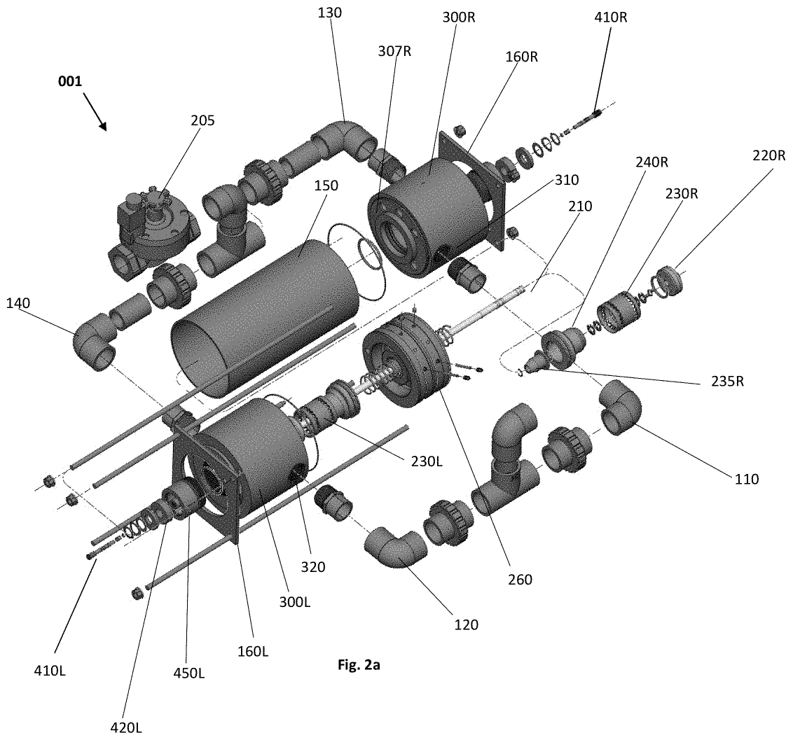

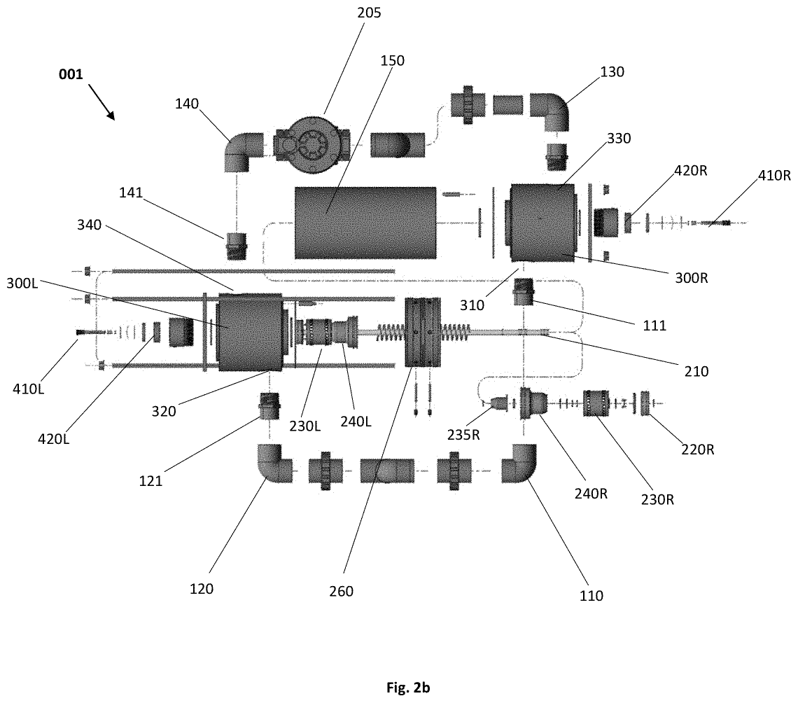

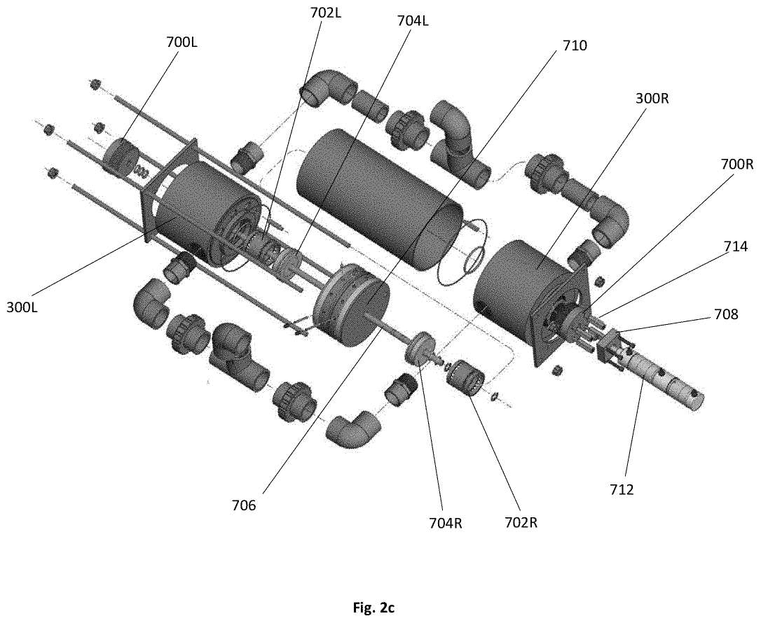

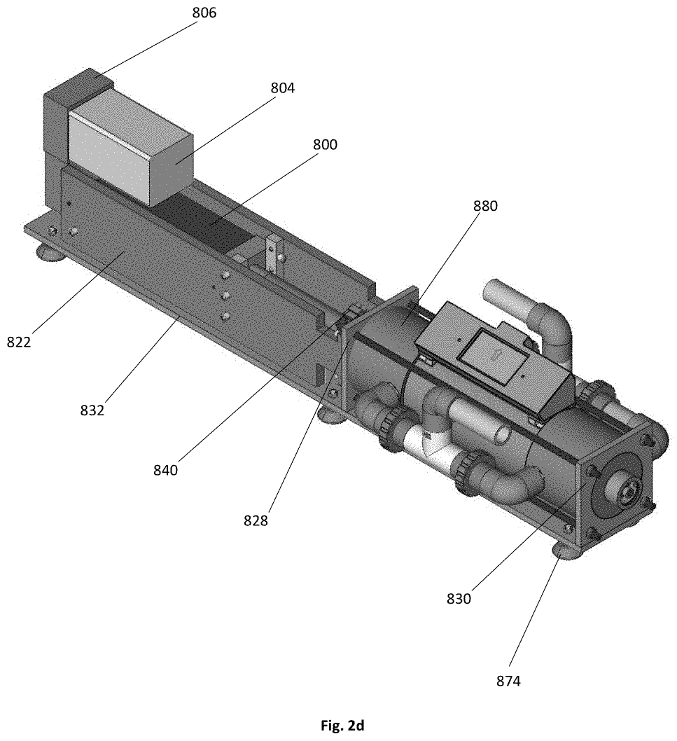

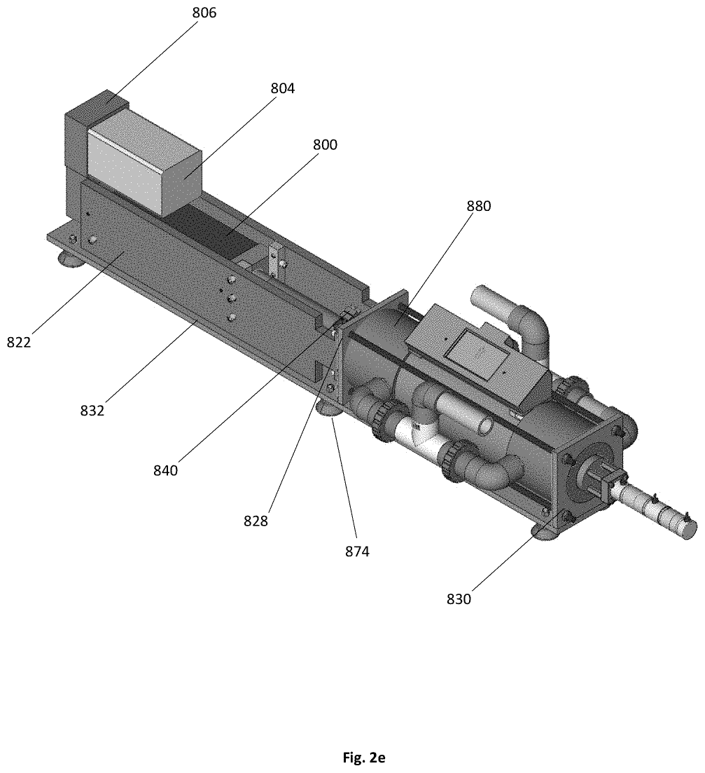

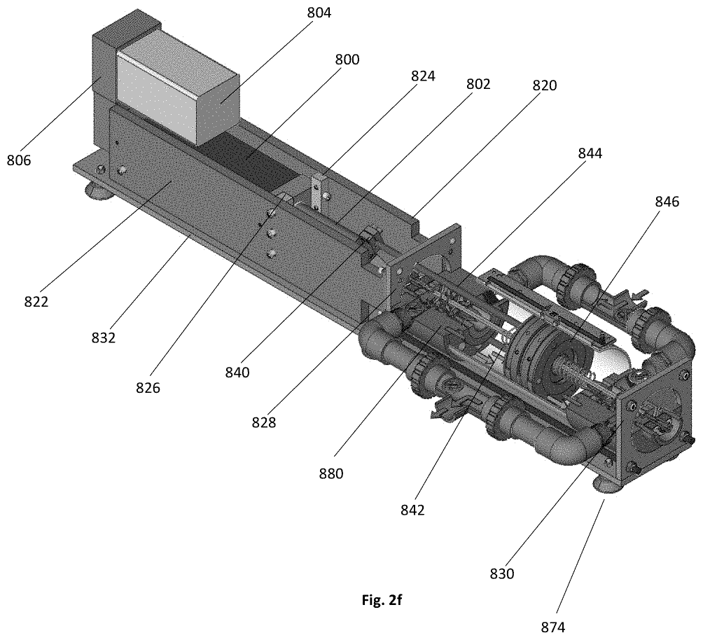

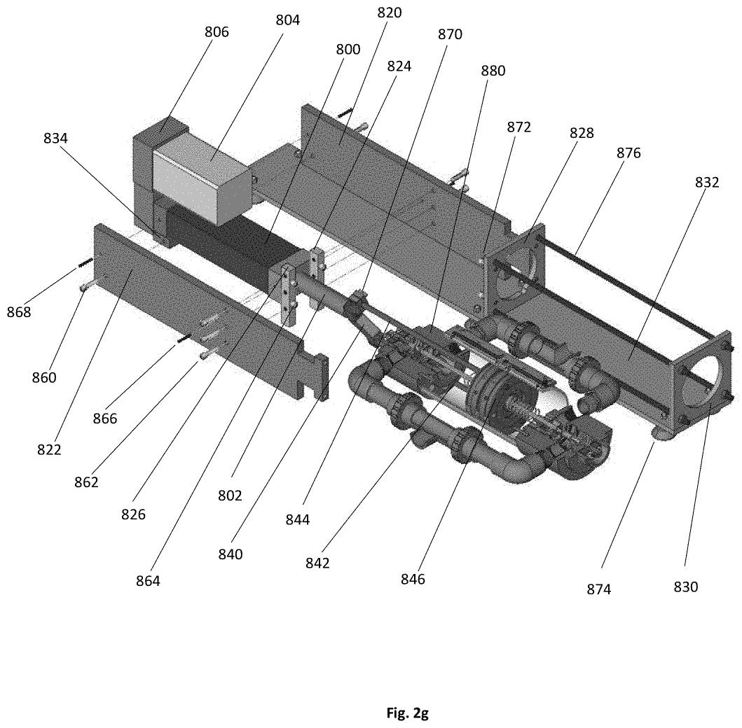

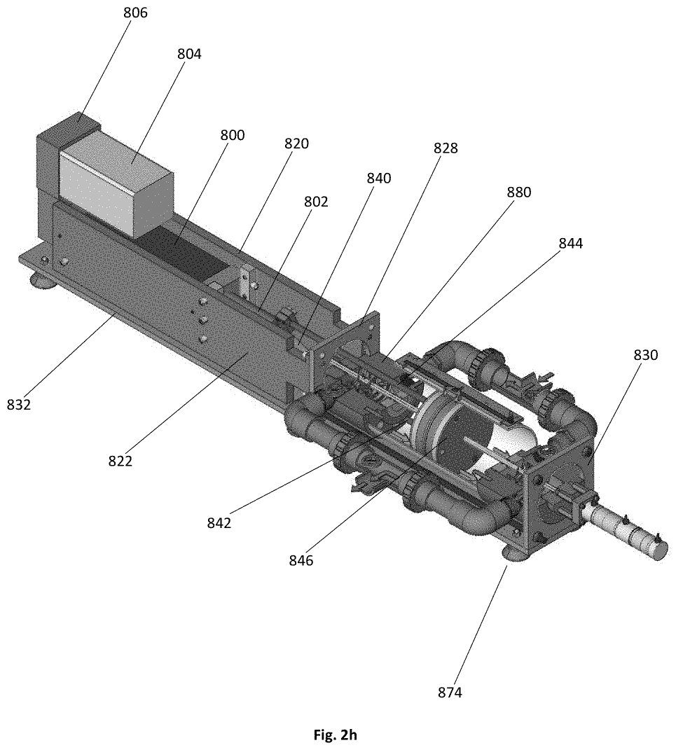

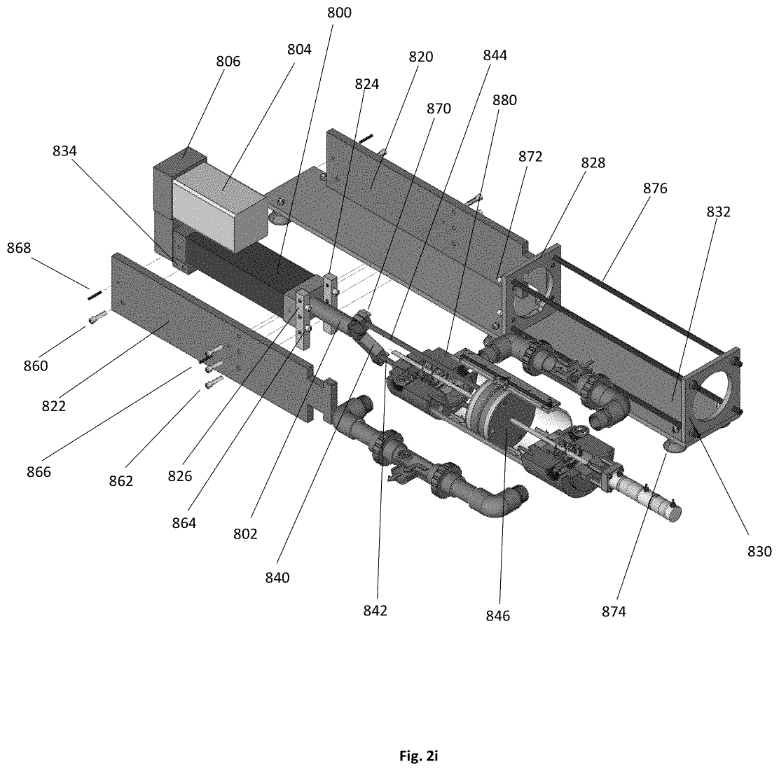

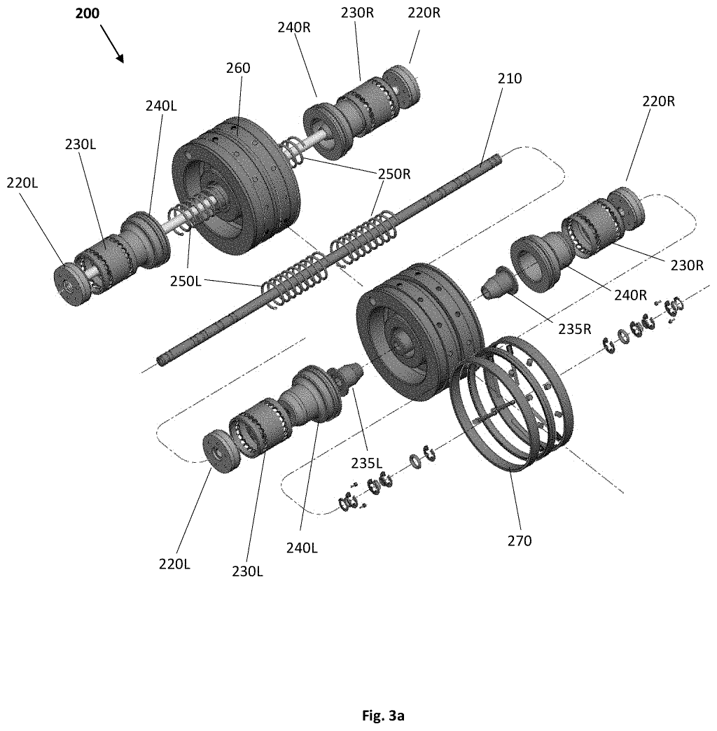

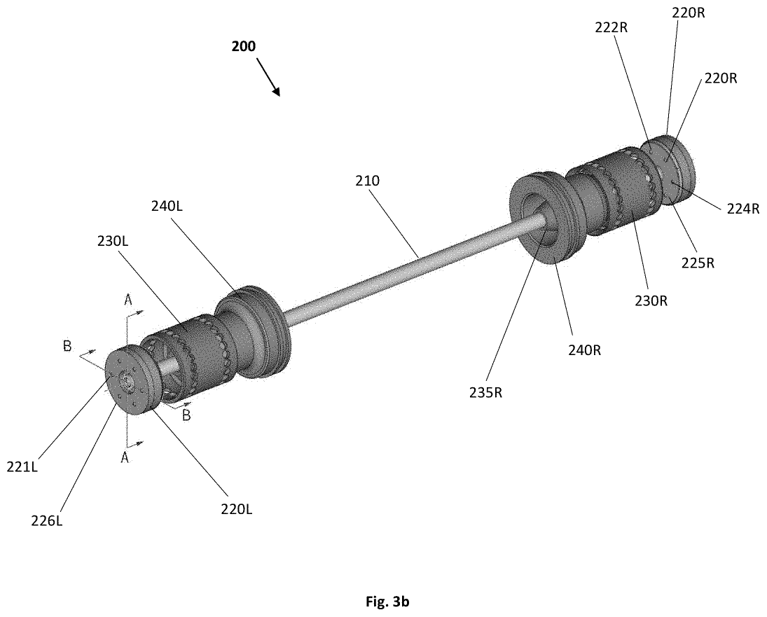

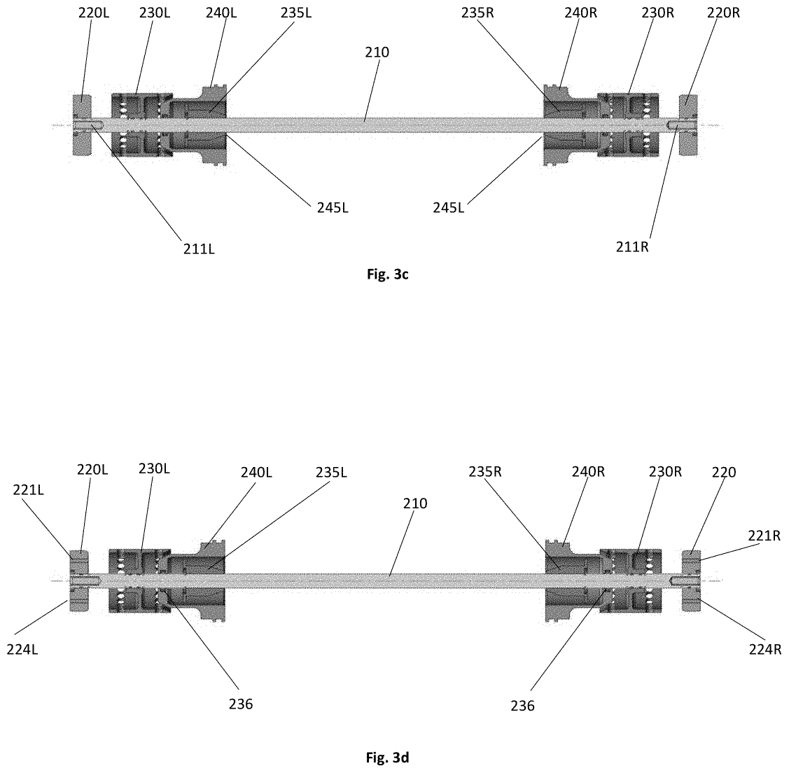

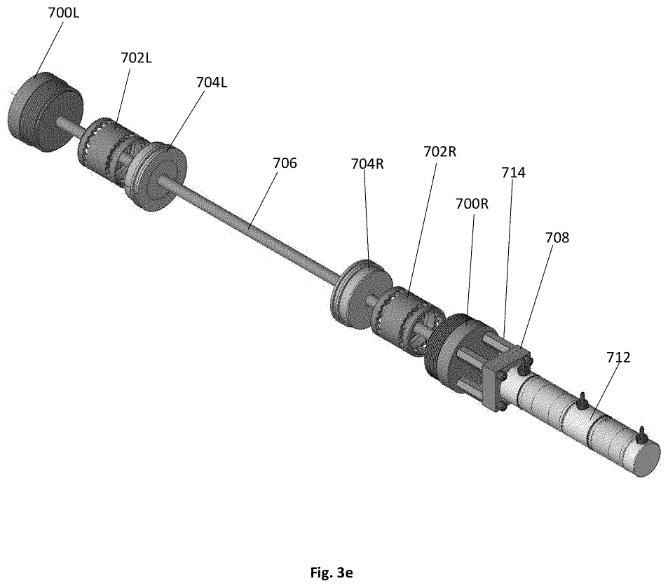

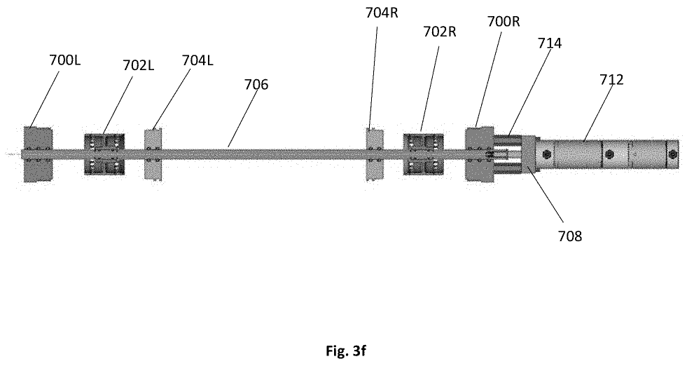

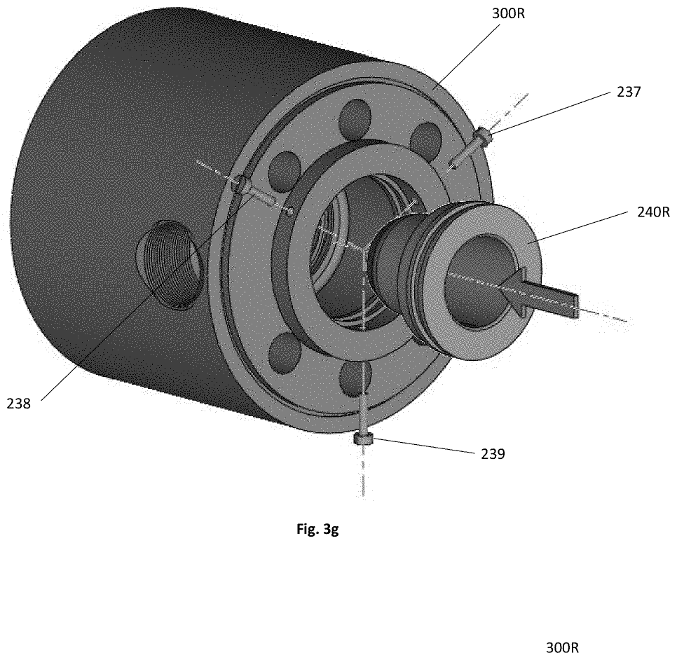

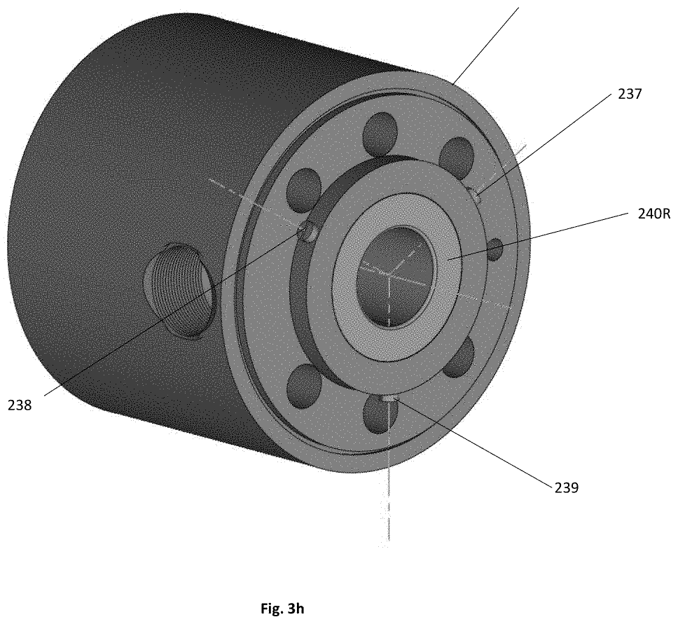

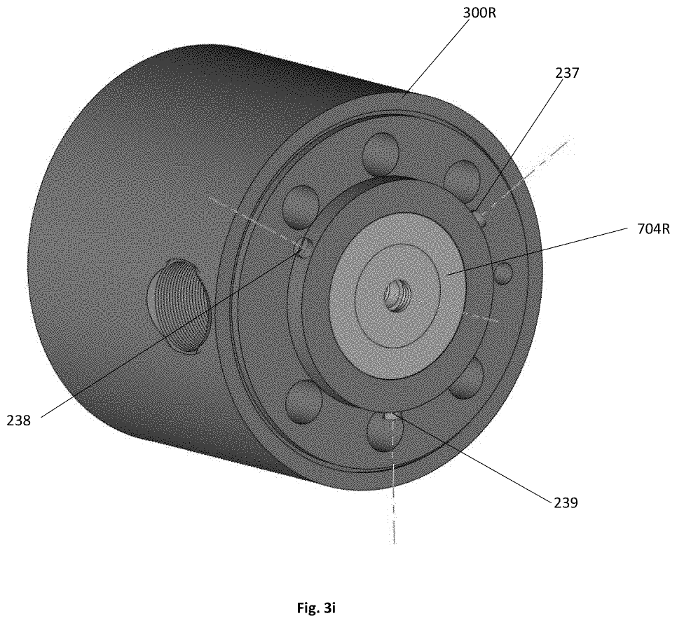

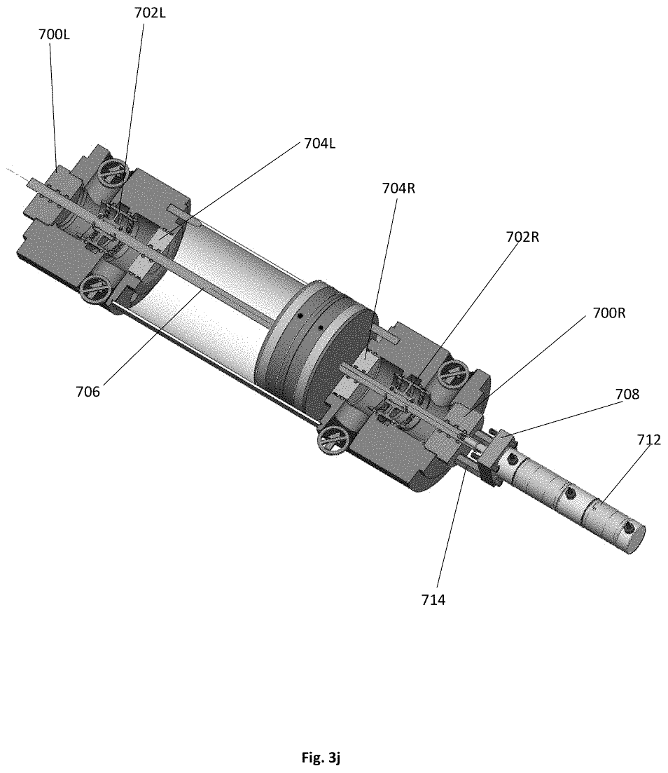

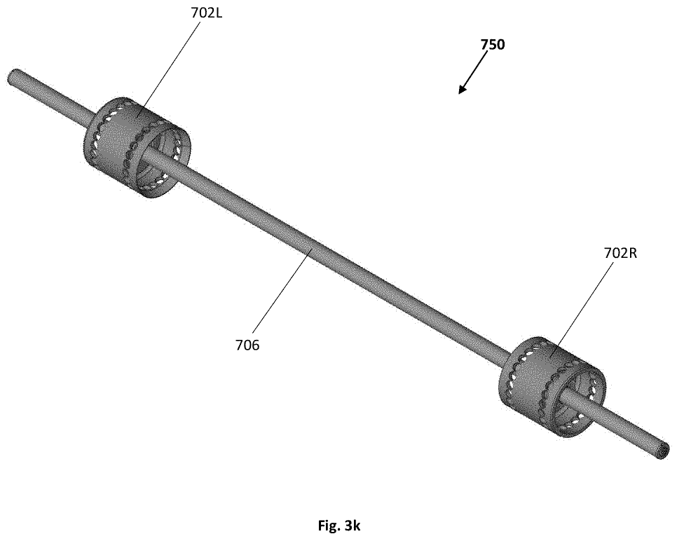

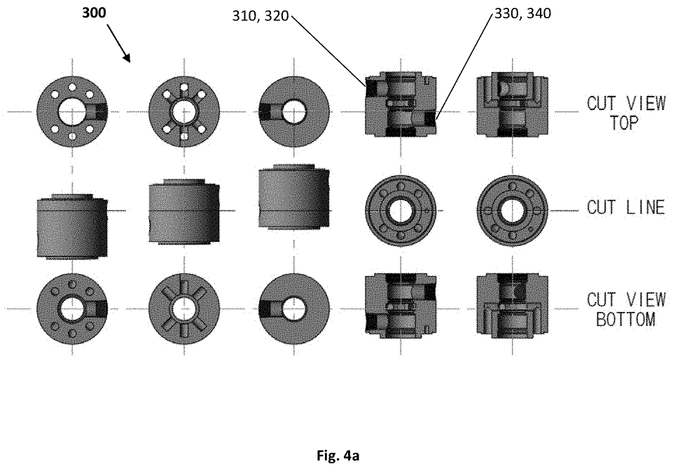

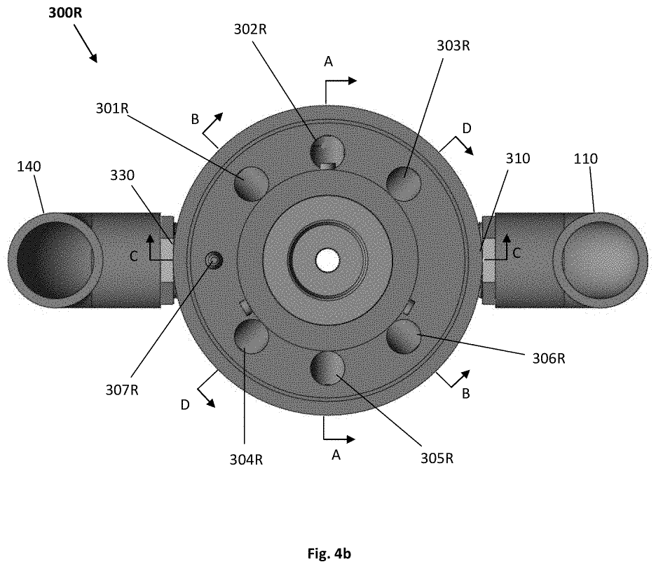

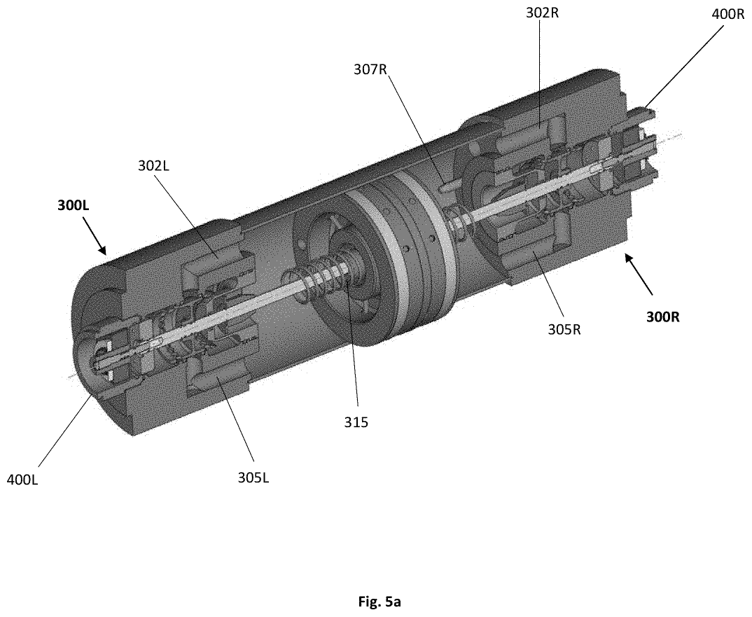

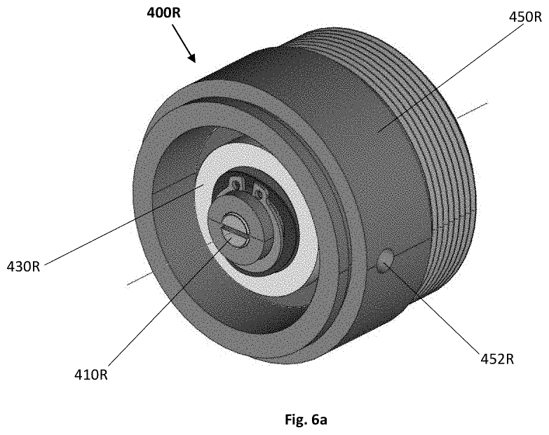

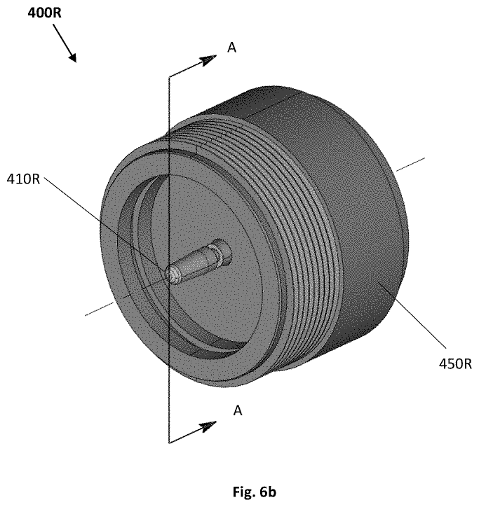

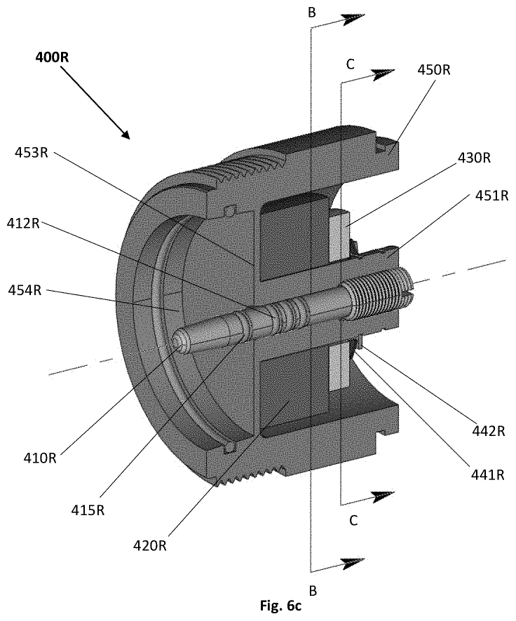

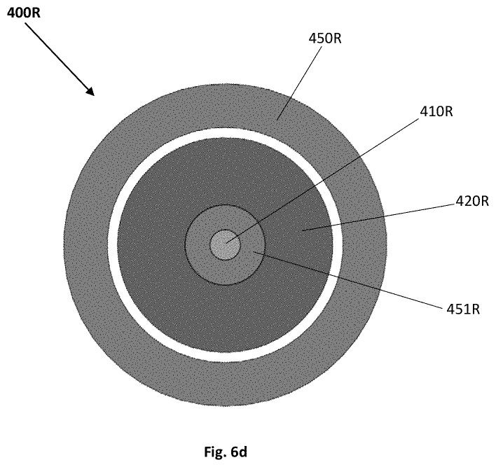

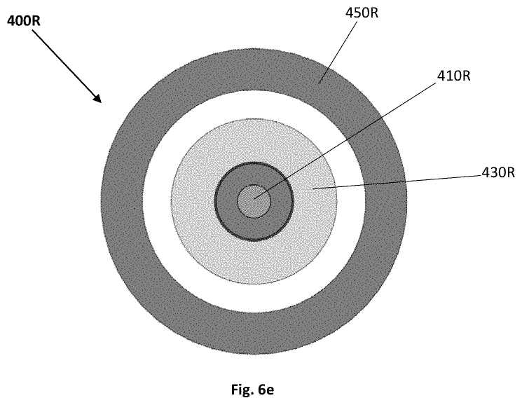

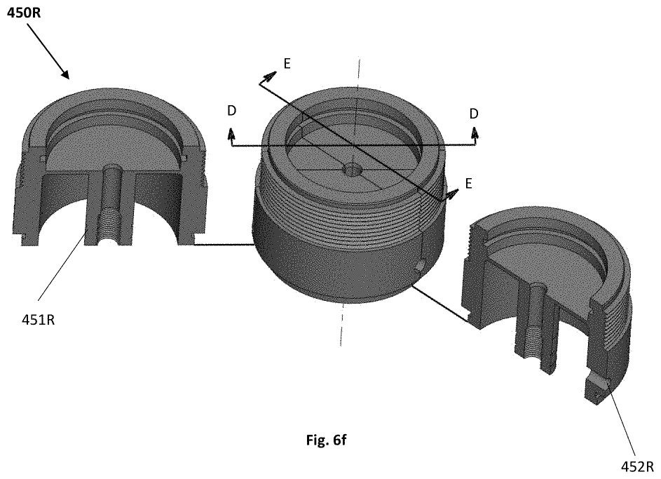

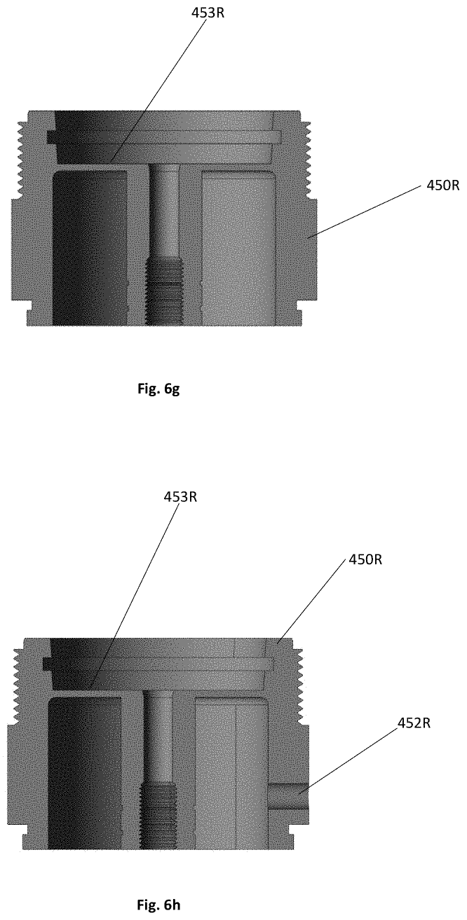

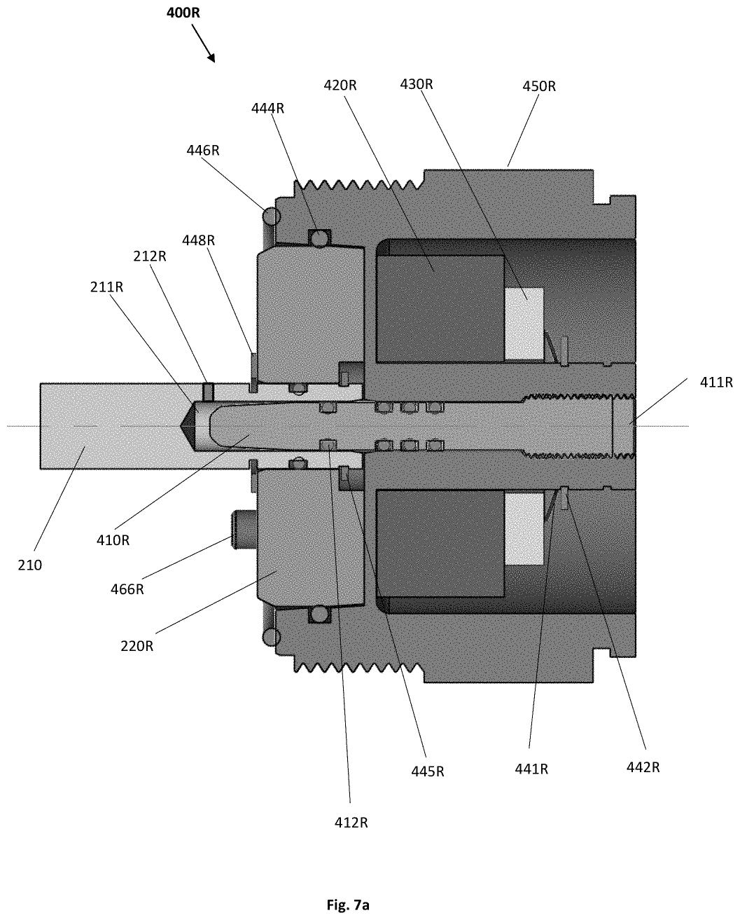

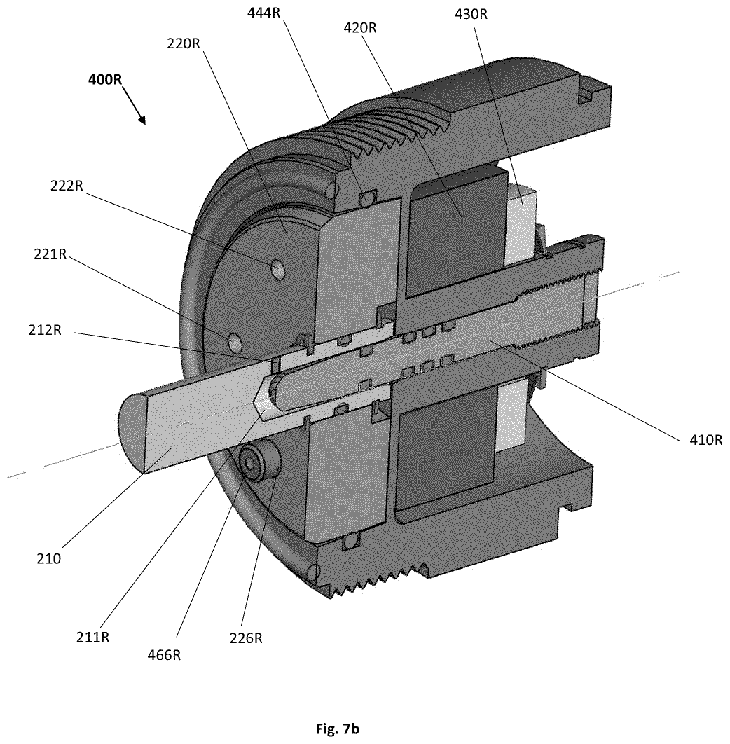

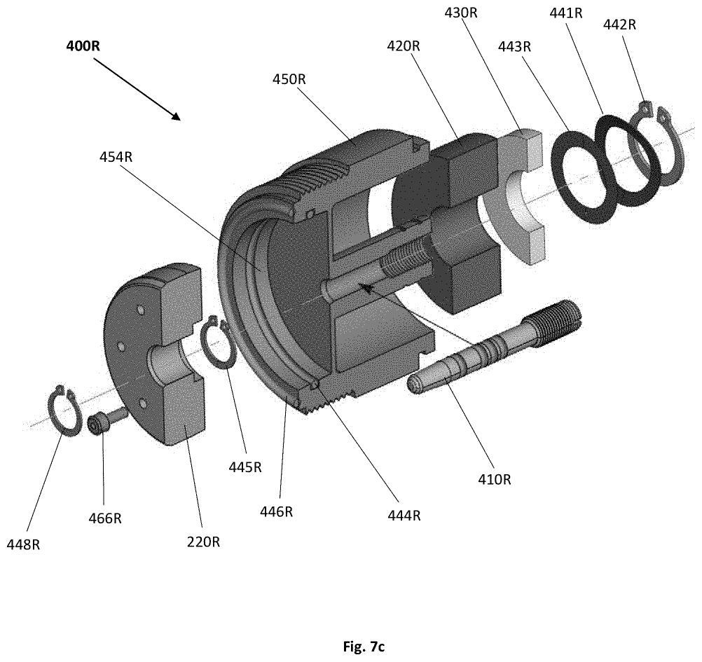

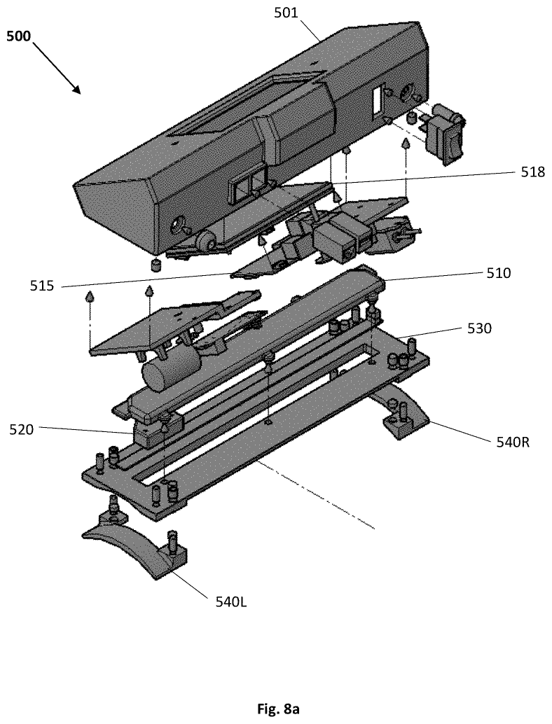

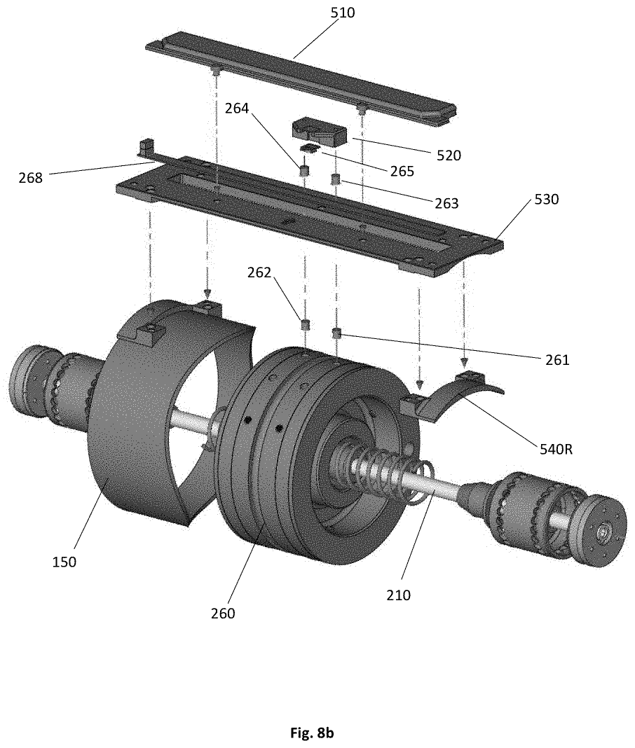

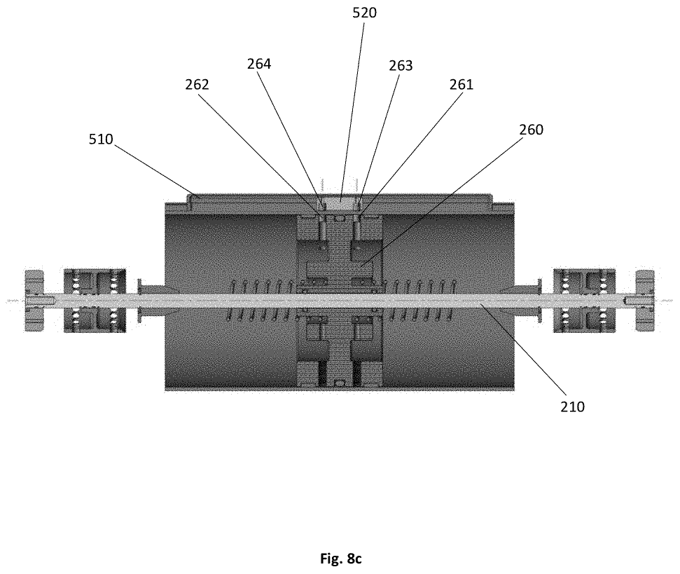

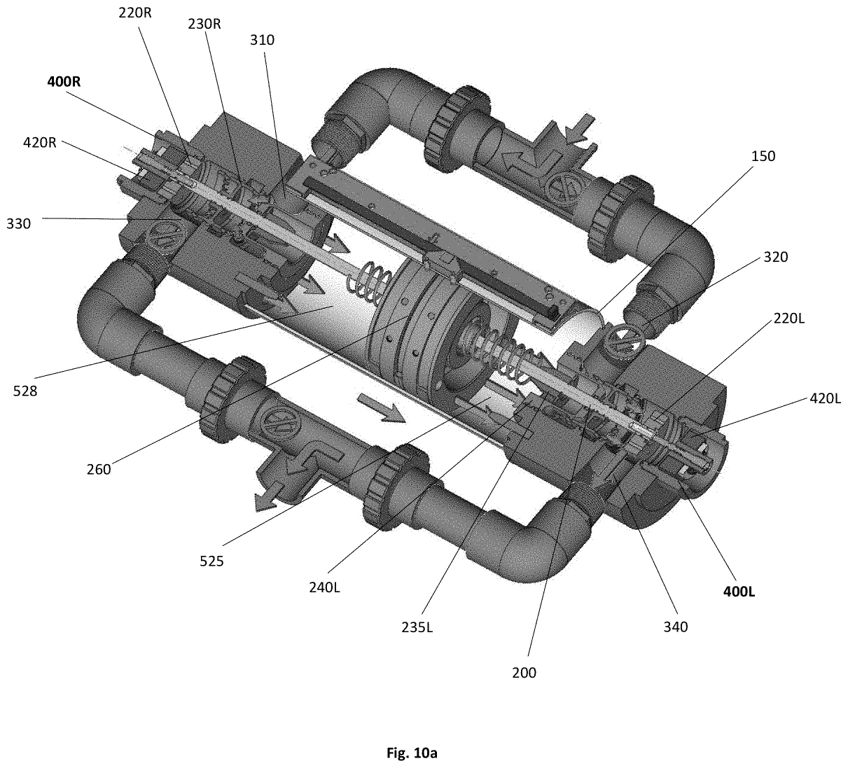

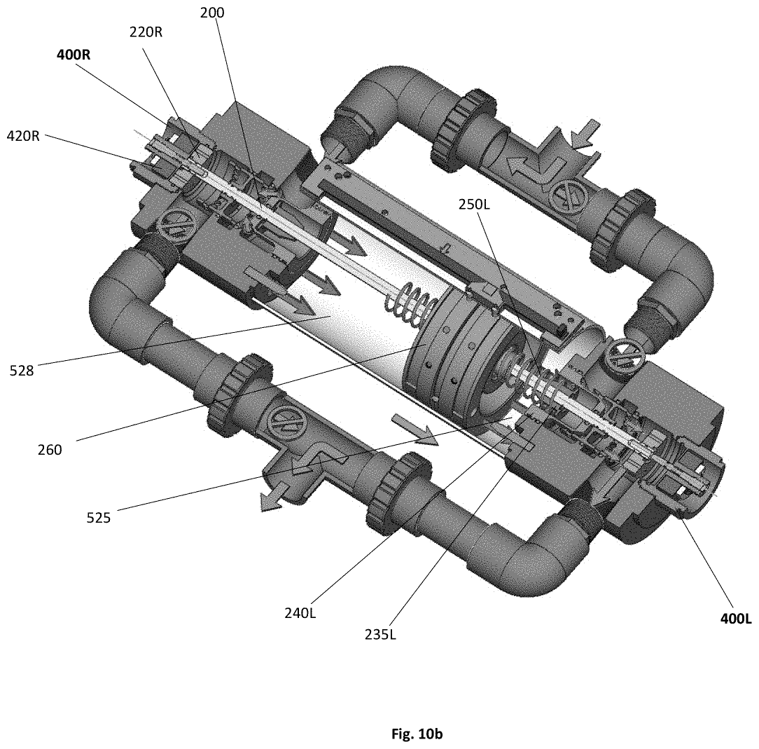

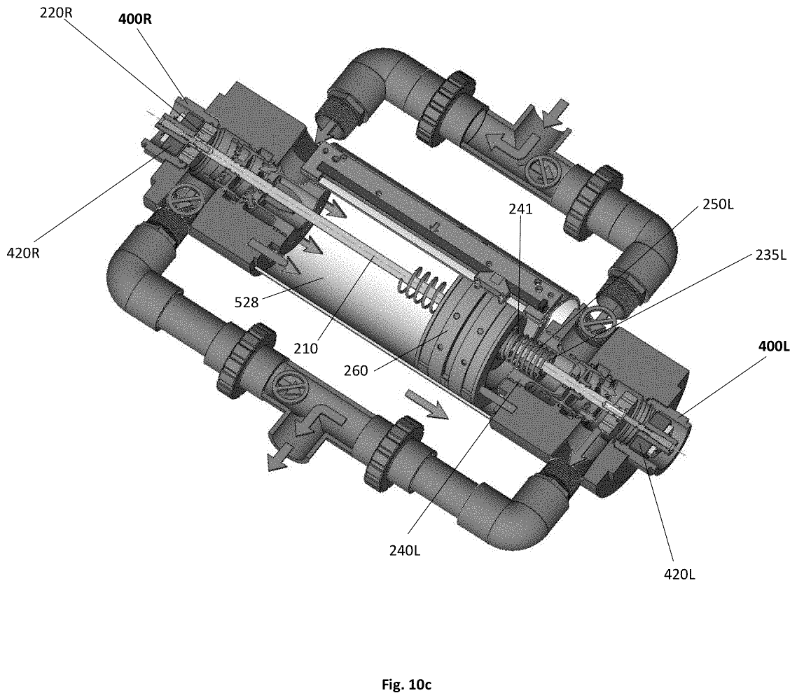

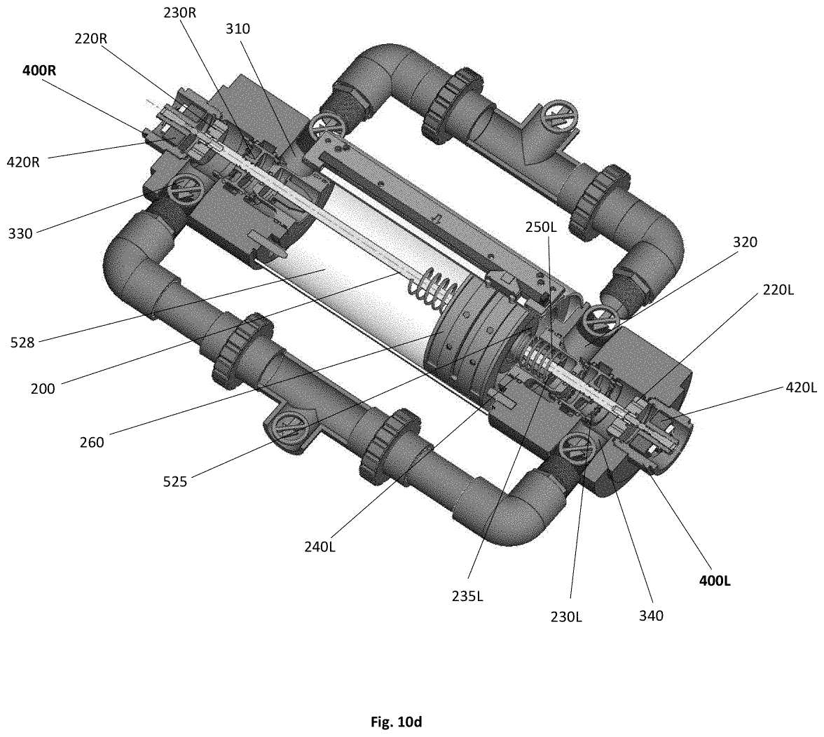

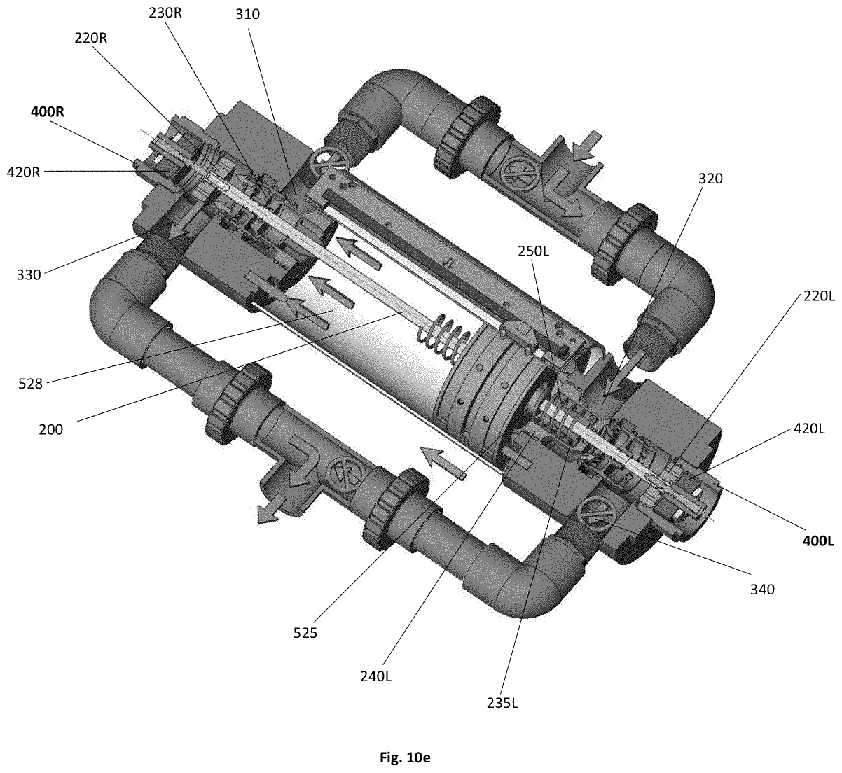

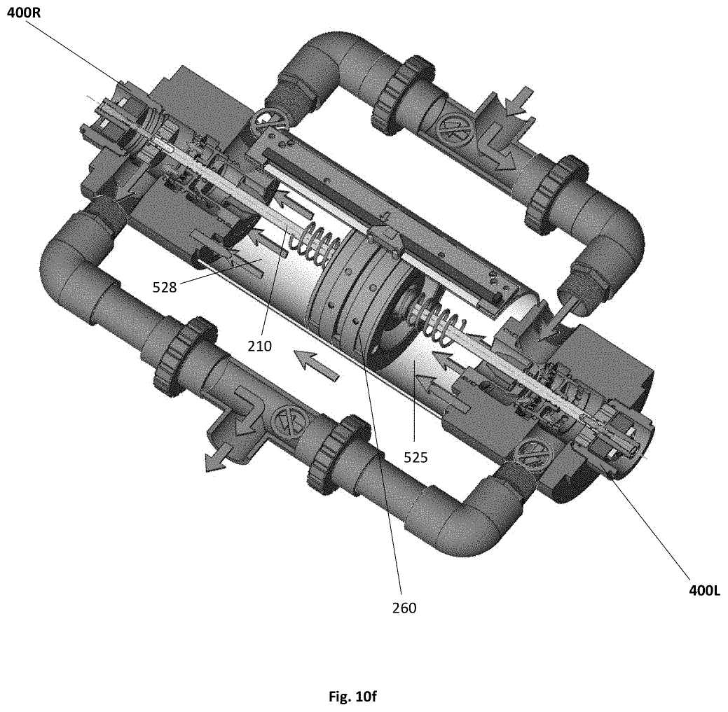

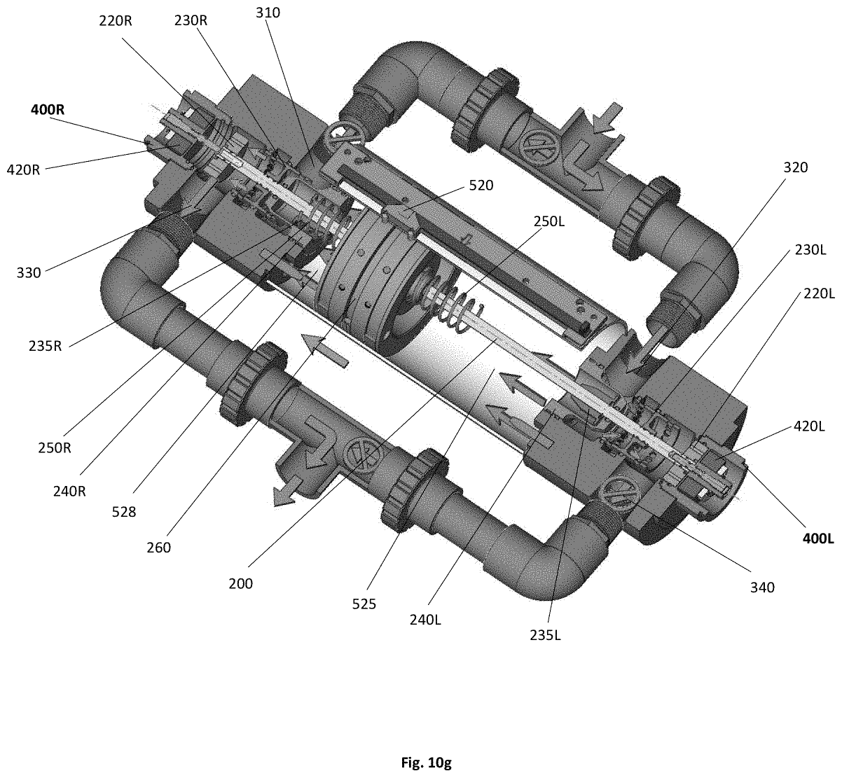

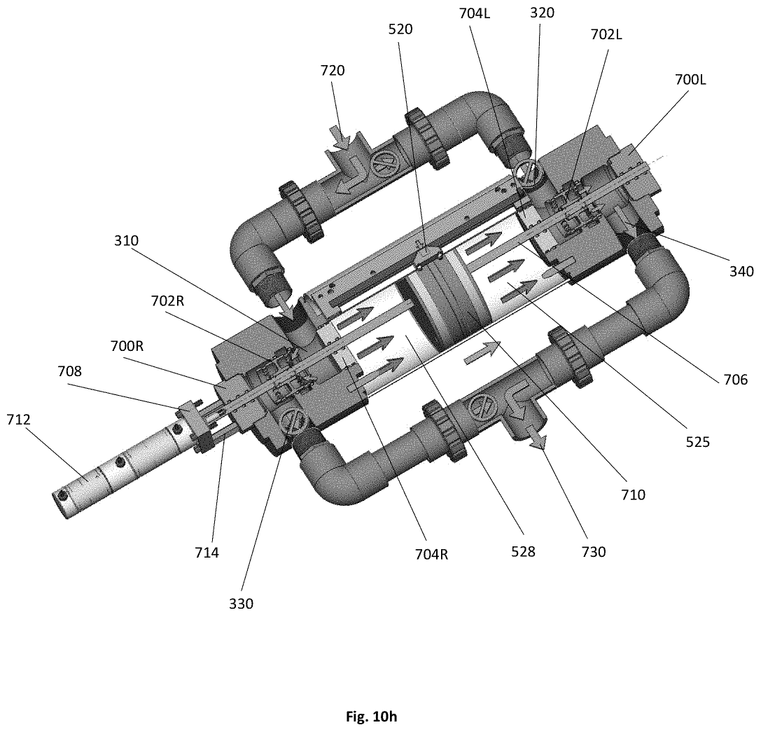

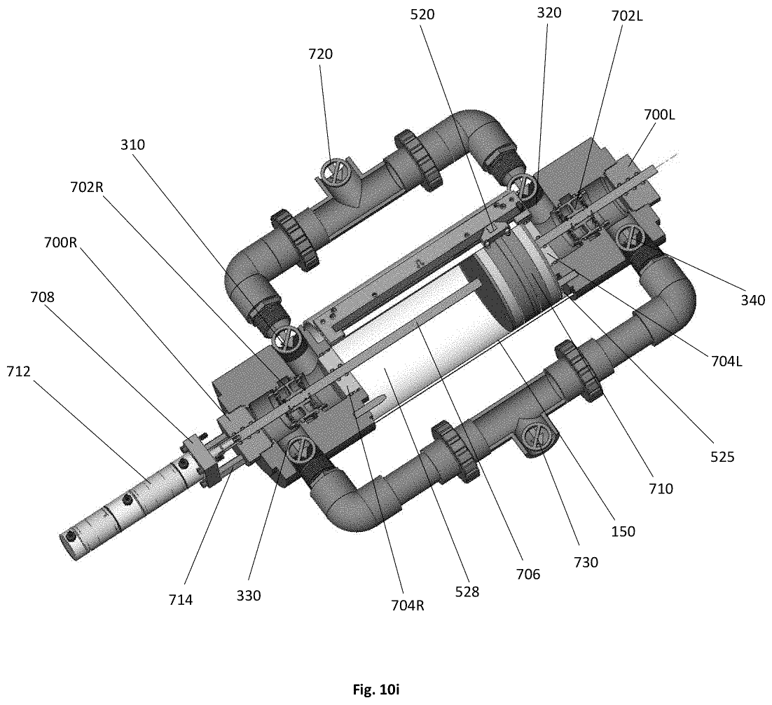

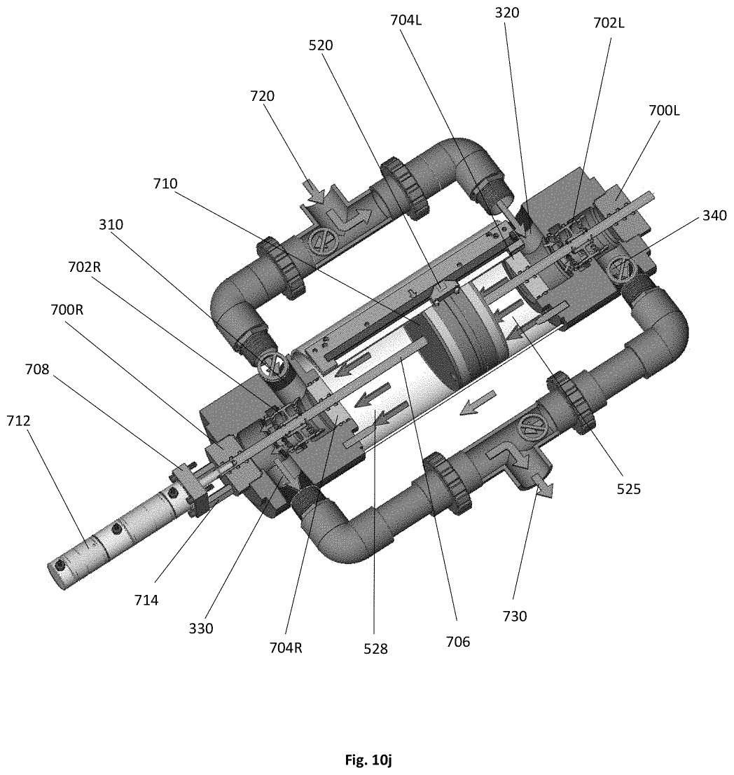

The primary components which makeup the invention in its totality are depicted in FIGS. 1a, 1b, 1c and 1d. The device is comprised of 8 primary parts, which include: 1) Inlet and outlet ports, 2) Endcaps, 3) Piston/cylinder housing, 4) Pushrod assembly, 5) Sealing components, 6) External valve (primary embodiment), Internal valve (alternate embodiment (A)), 7) Linear encoder, 8) RPM Computer.
1. Inlet and Outlet Ports—Each endcap (FIG. 2a-b, 300R, 300L) contains one inlet port (310, 320) and one outlet port (330, 340). The media to be measured enters the device through a single orifice (FIG. 1c 101), continues through a short network of pipe, and enters the device through one of two open inlet ports (310, 320).
Each inlet and outlet port open and close in unison with one and other and will always act in opposition to each other. Example (FIG. 2b), when endcap 300R has an open inlet port (310) and a closed outlet port (330), endcap 300L will have a closed inlet port (320) and an open outlet port (340). Once the media flowing through the device has been measured, it exits the device through one of two outlet ports (330, 340). Note that the media being measured will always exit the same endcap in which it entered. When the valves shift position, the inlet and outlet positions shift from open to closed on both sides simultaneously. It is not possible for a given amount of fluid to enter the device through port 310 and exit the device through the opposite outlet (340) and vice versa. It will always exit from the same endcap in which it entered, in this case, outlet port 330.
2. Endcaps—The two endcaps (300R, 300L) are identical to one and other. Each contain a 3-position valve which is rigidly coupled through a pushrod to the opposite endcap. The position of each valve inside of the endcaps operates in opposition to its counterpart. In other words, when the inlet port on endcap 300L is closed, the inlet port on 300R is open, the same is true for each outlet port. It is not physically possible for any two inlet or outlet ports to be open at the same time.
When the valve in each endcap is shifting to a new position, both valves will transition through a fully closed position (inlet ports 310, 320 and outlet ports 330, 340 will all be closed momentarily). By swiftly moving through this fully closed position, fluid is prevented from moving directly from an inlet to an outlet, which would impact the meters accuracy. The brief backpressure created by the closed valves is elevated through a hydraulic surge arresting device.
3. Piston/Cylinder Housing—The cylinder housing (FIG. 2b, 150) contains the piston (260), which moves longitudinally along the length of cylinder 150. It is the pistons displacement, measured by the linear encoder, which allows the device to accurately measure rate and volume. When any given amount of fluid enters the device, it will always displace an equal amount of fluid exiting the device.
Rigidly attached to each face of the piston, about the pistons central axis, are springs (FIG. 3a, 250R, 250L). The springs, when compressed by the piston, provide the energy to shift the position of each valve inside of each endcap to its new position. This action causes a reversal in flow, forcing the piston to reverse direction at the end of its travel length.
Alternate embodiment (A) does not contain springs 250L and 250R. When the piston reaches its full travel length, the encoder which tracks the position of the piston will signal the RPM's computer to shift the position of the pushrod valve assembly (FIG. 3k, 750) to the opposite side. This action causes a reversal in flow, forcing the piston to reverse direction at the end of its travel length.
4. Pushrod Assembly—Running through the center of the device, along the longitudinal centerline is a solid pushrod (FIG. 3a, 210). Affixed to pushrod 210 are 6 parts, all of which are rigidly attached to pushrod 210. The left and right sides of pushrod assembly 200 (FIG. 3b), are symmetrical to one and other.
Rigidly attached to pushrod 210, are the spring catch (235L, 235R), the perforated spindle valves (230L, 230R), and the engaging elements, or plates (220L, 220R) see FIG. 3b.
Rigidly attached to endcaps 300L and 300R (FIG. 3e-f), is the pushrod guide (FIG. 3a-d, 240L, 240R). Pushrod 210 moves longitudinally through the central axis of the fixed pushrod guide when the pushrod shifts valve positions. The pushrod is sealed by an O-ring mounted inside the bore of part 240L and 240R (FIG. 3d point 236). The pushrod guide serves to seal cylinder housing 150 from the valve in either endcap.
Pushrod assembly 750 (FIG. 3k) of alternate embodiment (A) differs from the primary embodiment. In alternate embodiment (A), engaging elements (220L and 220R) and spring catches (235L and 235R) are not required. Additionally perforated spindle valves 230L and 230R and pushrod guides 240L and 240R, while performing the same function, take a different shape.
Rigidly attached to pushrod 706 (FIG. 3e-3f) of alternate embodiment (A), are perforated spindle valves 702L and 702R. Pushrod 706 moves longitudinally through the central axis of pushrod guides 704L and 704R, and sealing members 700L and 700R, both of which are rigidly attached to endcaps 300L and 300R (Reference FIGS. 2c and 3i)
5. Sealing Components (Primary Embodiment)—Affixed to each end of the device, along the longitudinal centerline, are sealing components (400L, 400R). Each component serves three purposes.
1) It houses the magnet which directly opposes the energy created by springs 250L and 250R.
2) It serves to slow the velocity at which the pushrod, specifically part 220 L and R, make direct contact with surface 453L and 453R of part 450 (FIG. 6c, 7b).
3) It houses damping pin 410L and 410R (FIG. 7a-b), which are used to provide fine adjustment to the damping mechanism.
Sealing Components (Alternate Embodiment (A)—Affixed to each end of the device, along the longitudinal centerline, are sealing components (700L and 700R). Each component serves to align pushrod 706 with the centerline of the device.
6. External Valve—Primary valve (FIG. 1a, 1b, 205) starts and stops the flow of fluid exiting the invention. The valve can be programmed via the computer inside the encoder housing (501) to start and stop at specific volumes and time intervals.
Internal Valve—Alternate embodiment (A) does not require an external valve to start and stop flow. The air cylinder or motor (FIG. 3e, 712) can stop the motion of the pushrod assembly (FIG. 3k, 750) and rigidly attached perforated spindle valves (702L and 702R) at exactly ½ its travel length. This ½ way point, or second position, closes all 4 chambers, stopping the flow of media entering or exiting the device.
FIG. 10i is a cross-sectional view of alternate embodiment (A) of FIG. 1d. Along line C-C in FIG. 4b, showing the pushrod assembly (FIG. 3k, 750) in a second position, where the first passage (310) (between first inlet and first chamber 528) is closed, the second passage (320) (between second inlet and second chamber 525) is closed, the third passage (330) (between first chamber 528 and first outlet) is closed, the fourth passage (340) (between second chamber 525 and second outlet) is closed.
When the invention is used to measure specific quantities of fluid, (example—a batching or custody transfer application) or stop the flow of media when a specific flow rate has been exceeded (a leak detection application), the device can be programmed to automatically stop in this second position, as depicted in FIG. 10i.
7. Linear Encoder—The linear encoder, which is comprised of the encoder board (FIG. 8b 268), the encoder target (265), the encoder target/magnet housing (520), encoder wire guard (510), and the encoder magnets (261, 262, 263, 264).
The linear encoder tracks the position of piston 260 (or 710 for alternate embodiment (A) inside of cylinder housing 150. Magnets 263 and 264 move in unison with magnets 261 and 262 (FIG. 8c). Magnets 263 and 264 are mounted inside of the encoder target/magnet housing (520). As the magnets move to track the position of the piston, housing 520 moves across the linear encoder board (268). Encoder board 268 is rigidly mounted to the base of the linear encoder housing (530)
8. RPM Computer—The computer (ref FIG. 8a, 515) is housed inside of the linear encoder/display housing (500) and sits immediately below the 5-inch touch screen display (518). The computer displays, computes and stores data associated with input from the user, along with processing position information relayed to it from the linear encoder. It controls when, and in what time duration the external valve will open and close, allowing the device to function as a batching, dosing, custody transfer and leak detection system. Further its diagnostic function allows maintenance to be performed on the device both remotely (via Wi-Fi) and in person. This information is displayed to the user via the 5-inch touch screen display, or via a handheld tablet.

In reference to alternate embodiment (A), the RPM computer also serves to command air cylinder/motor 712 to a first (FIG. 10h), second (FIG. 10i) and third (FIG. 10j) position, in coordination with input from linear encoder target 520 (FIG. 10h-10i), and/or a specific volume, leak or other condition which would require flow to stop.

It should be noted that both the primary and alternate embodiment (A) can employ the use of a hydraulic dampener or accumulator on the inflow and/or outflow sides of the device to mitigate the effects of hydraulic shock.

### Primary Embodiment (Spring/Magnet) Detailed Description

FIG. 2a is an exploded perspective view of the reciprocating fluid meter of FIG. 1a, without the display 501. FIG. 2b is an exploded top plan view of the reciprocating fluid meter of FIG. 2a of the primary embodiment.

FIG. 1a-c, FIG. 2a-b depict primary valve 205 of the primary embodiment rigidly coupled to the outlet manifold assembly (FIG. 1c 130, 140, 180, 185, 190, 199) between pipe elbow 190 and outlet pipe 199. Primary valve 205 is a two position, open/closed valve which starts and stops the flow of fluid exiting the device. The valve can be controlled both manually and automatically. This valve does not appear on alternate embodiment (A).

Manual actuation of primary valve 205 is controlled in two ways, through the rotation of a dial atop valve 205, or through the inventions interface.

Automatic operation of primary valve 205 is a direct function of the RPM computer. Valve 205 will start and stop the flow of fluid in accordance with a given set of commands programmed by the user of the invention. The valve will automatically open or close in conjunction with the following:

Leak detection—Primary valve 205 will stop the flow of fluid passing through the invention should the rate, mass or volume of said fluid exceed programmed parameters set by the user of the device.

Batching/Dosing/Compounding operations—Primary valve 205 will automatically open and close in conjunction with a predetermined volume or mass of fluid passing through the invention. The predetermined volume or mass can be determined using an output signal of the encoder tracking device. This operation will repeat, allowing the user to fill multiple containers with a specific volume or mass of metered fluid, or perform similar tasks associated with batching, dosing or compounding operations. The time interval between the closed position and open position can also be programmed.

Custody transfer—Primary valve 205 will automatically open and close in conjunction with a predetermined volume or mass of fluid passing through the invention. The valve can also be manually opened/closed and the same volume/mass data will be displayed to the user, along with other ancillary information such as flow rate, temperature and velocity.

In preferred embodiments, pushrod (210) comprises an elongated member that can travel inside housing 150.

FIG. 3a is an exploded view of pushrod 200, piston 260 and related components in the reciprocating fluid meter of the primary embodiment 001 of FIG. 1a.

In the primary embodiment, the components which are rigidly attached to pushrod (210) or move along the longitudinal centerline of the pushrod can be seen in FIG. 3a. Piston 260 sits in the center of the pushrod (210). Both the ID and OD of the piston are sealed against the ID of the cylinder (150) and the OD of the pushrod (210). This prevents fluid from leaking to the opposite side of the piston, which would degrade the meters accuracy. Attached to each side of the piston, about the center of each face, are springs 250L and 250R. Each spring is compressed at the end of the pistons travel length between piston 260 and spring catch (FIG. 3b-c, 235L, 235R).

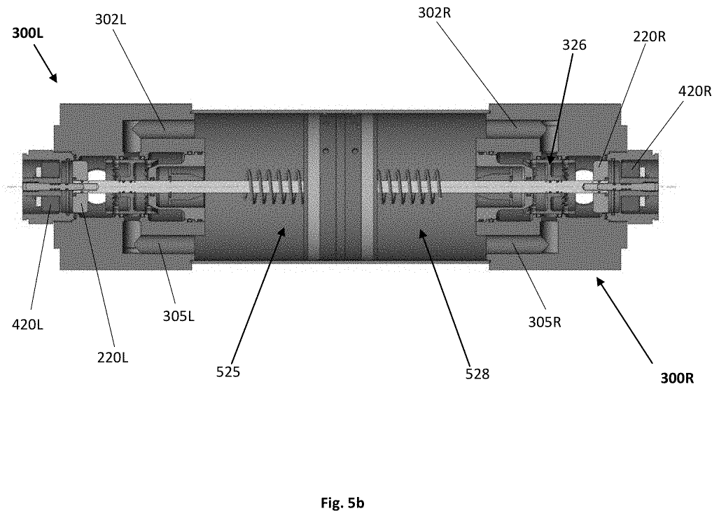

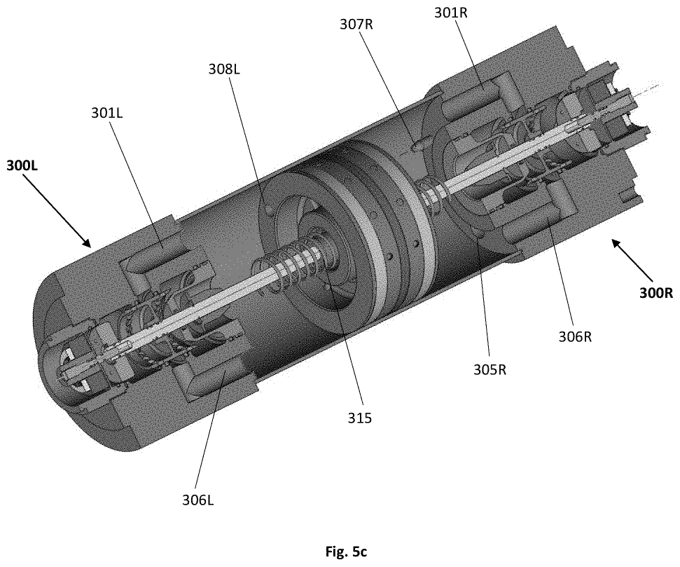

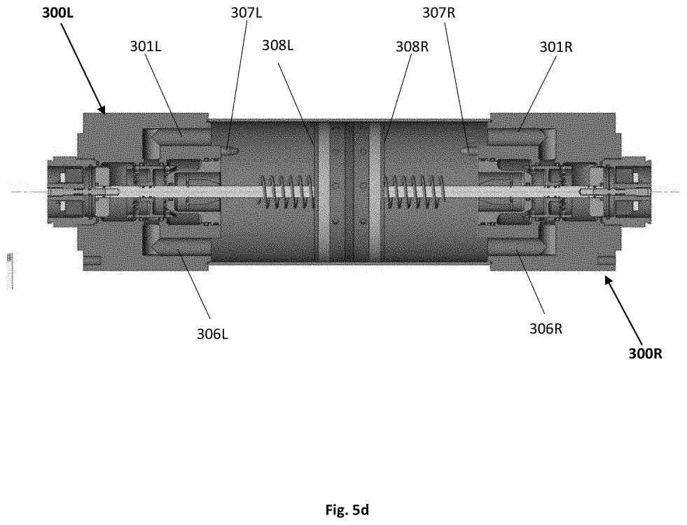

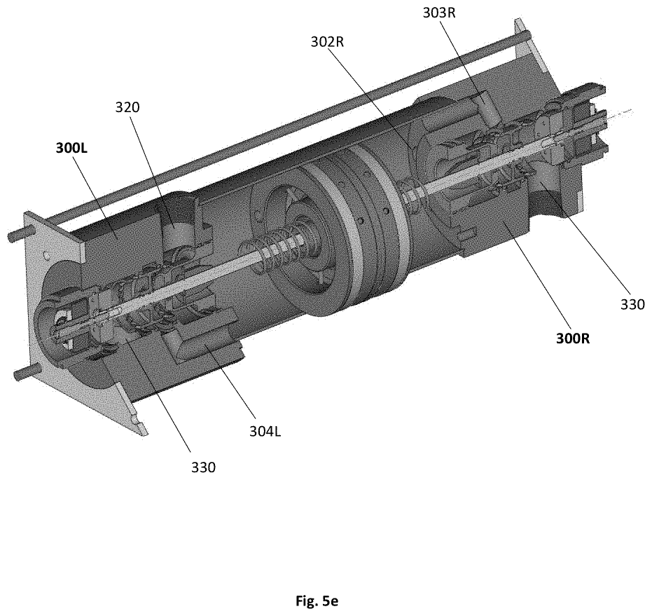

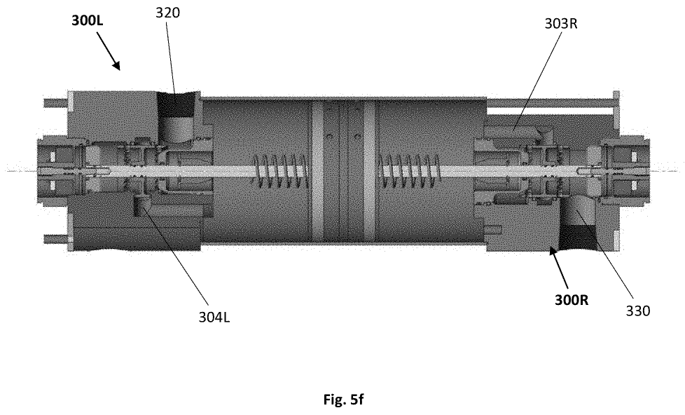

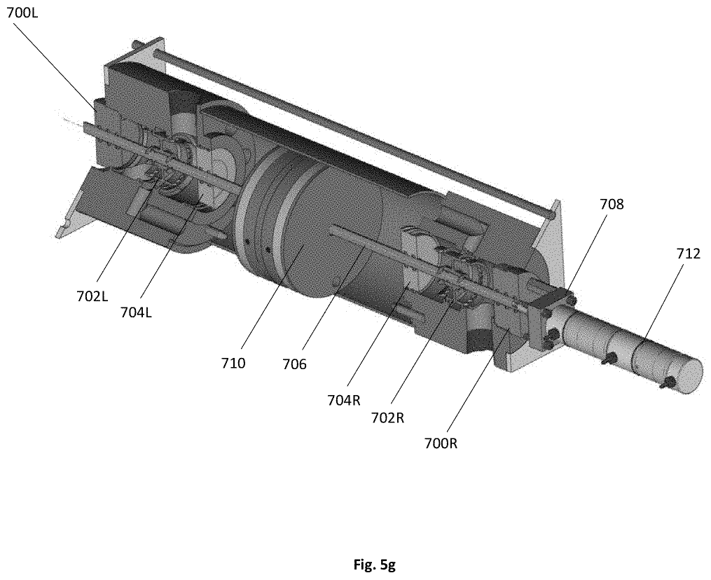

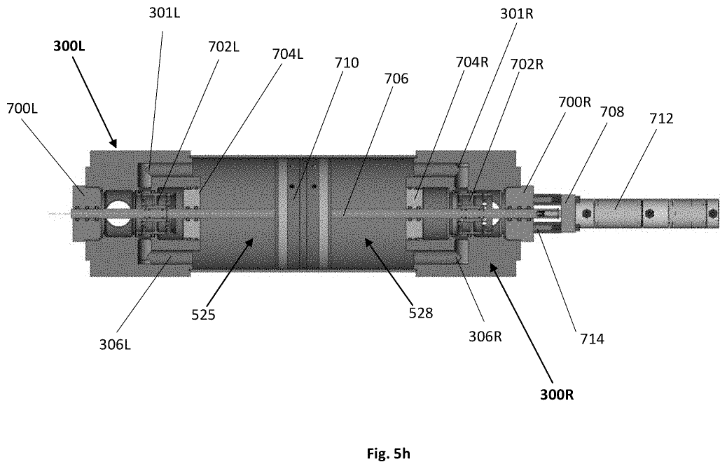

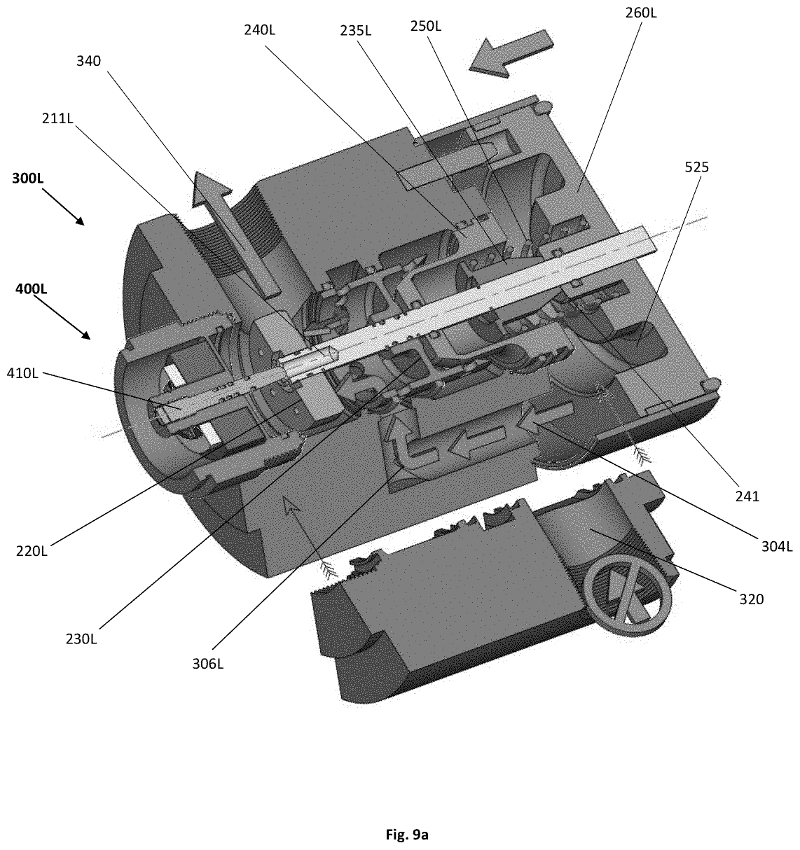

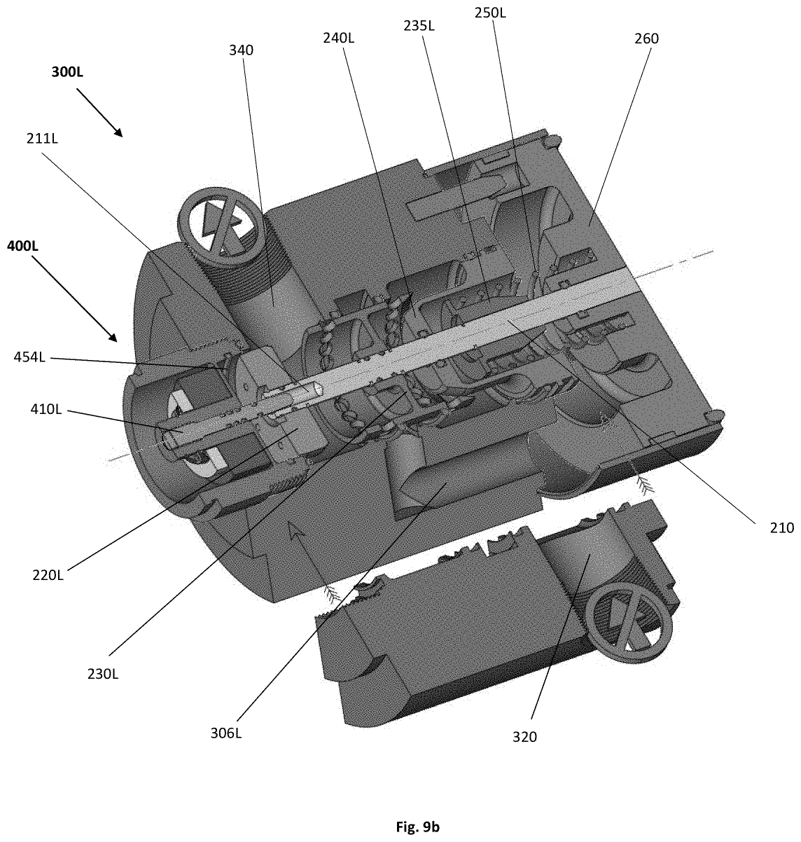

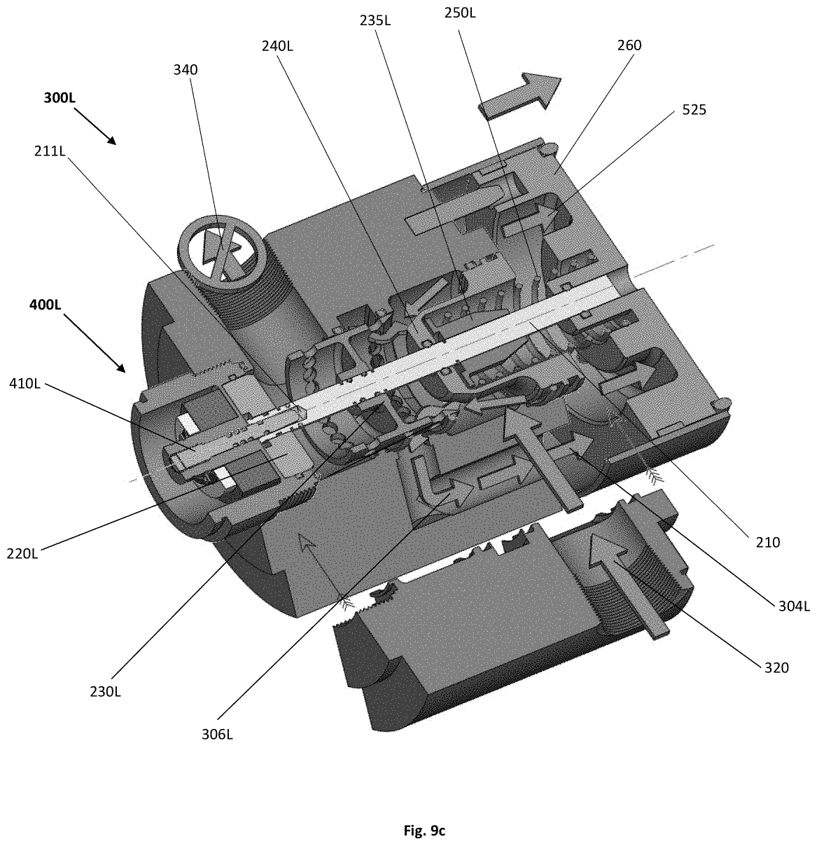

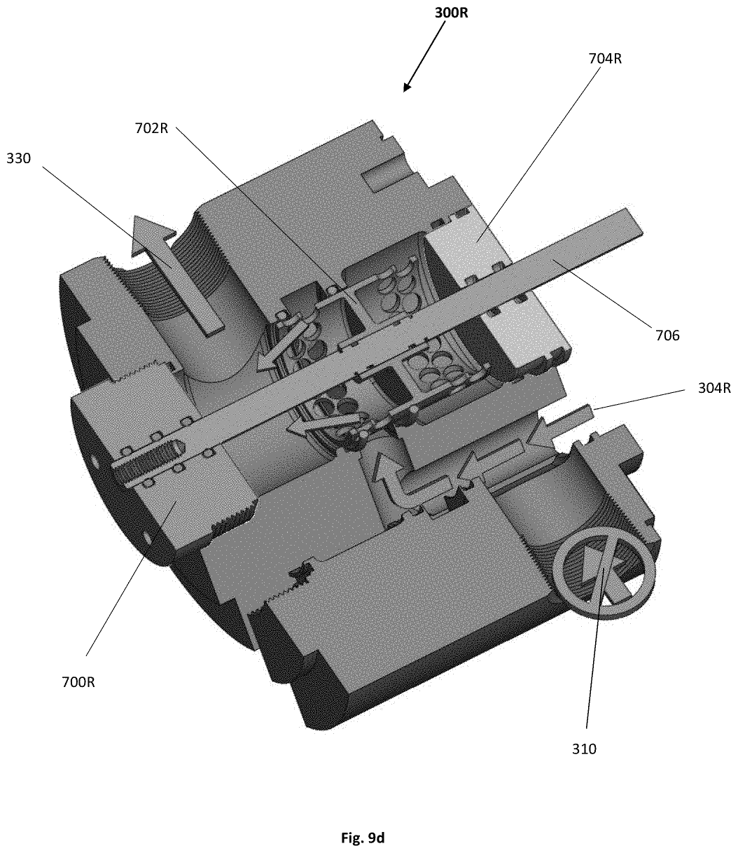

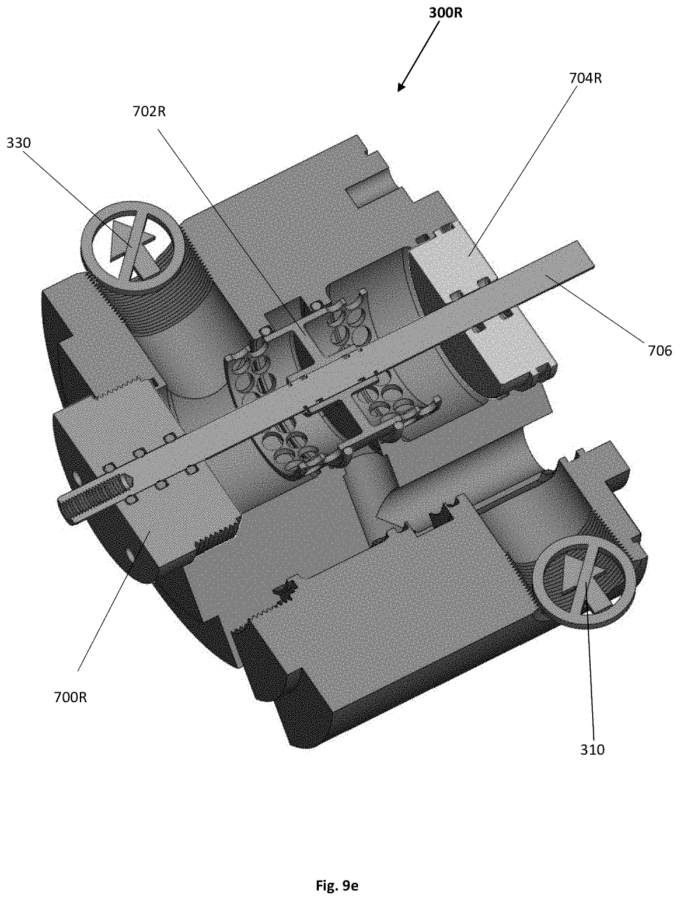

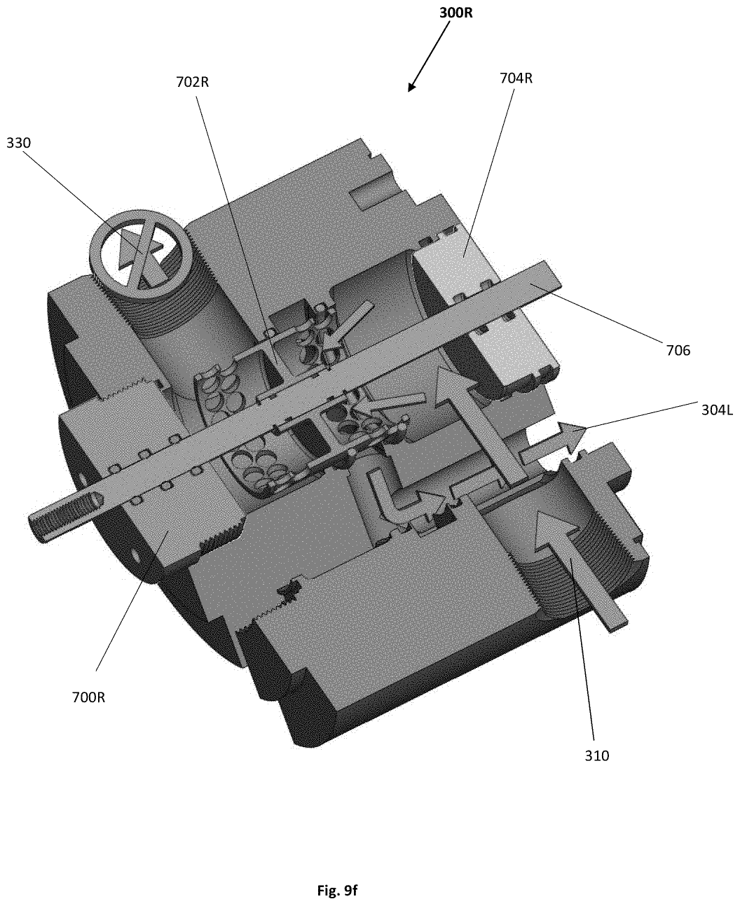

The spring catch (235L, 235R) is rigidly attached to pushrod 210, and therefore moves in unison with pushrod 210. When the piston approaches its maximum travel length, one of the two springs (250L, 250R) will be compressed between piston 260 and the internal face of 235L or 235R (refer to the cutaway view of part 235L and 235R in FIG. 3c, FIG. 9a). The piston will continue to compress the spring until the face of piston 260, specifically surface 315 (ref FIG. 5a, 5c), makes physical contact with the face of 235L or 235R, specifically surface 245 (ref FIG. 3c). Contact between these two surfaces will force the pushrod assembly (200) to break the magnetic union between 220L or 220R and the magnet (420L, 420R) (specifically surface 453R ref FIG. 6c) in either sealing component.

When the pushrod (which was held stationary during spring compression by magnet 420L or 420R) is dislodged from magnet 420L, the energy from the compressed spring will physically drive pushrod assembly 200 into its new seated position in the opposite sealing member, reversing flow and driving the piston in the opposite direction where the process will be repeated.

The rigidly attached perforated spindle valves (230L, 230R), both direct flow from an inlet port (310, 320) to a chamber (525, 528) or from a chamber to an outlet port (330, 340), allowing fluid to flow into the flood chamber inside of the cylinder, or flow out of the flood chamber and exit the device. At the same time the inflow or outflow port on the opposite side of each perforated spindle valves is sealed.

The perforated spindle valves allow media to flow through the plethora of holes in each valve without disengaging from the seal to which it is mated.

The rigidly attached engaging elements (220L, 220R) are mounted at the end of the pushrod assembly (FIG. 3b, 200). The purpose of the magnetic engaging elements is to hold the pushrod stationary against surface 453L or 453R, via the force generated by magnet 420L or 420R. During this time, when the piston approaches the end of its travel length, it will compress spring 250L or 250R. Once spring 250L or 250R is fully compressed, the piston will make direct physical contact with rigidly attached 235L or 235R at point 241 (FIG. 9a). The force of piston 260 pressing against spring catch 235L or 235R will break the magnetic union between the engaging element and the magnet at the opposite end of the device. Compressed spring 250L or 250R will then drive pushrod assembly 200 to its new seated position, shifting the valve positions and the piston will reverse.

FIG. 3b is a perspective view of pushrod assembly 200, FIG. 3c is a vertical cross-sectional view along line A-A in FIG. 3b, and FIG. 3d is a horizontal cross-sectional view (along line B-B in FIG. 3b) of pushrod assembly 200, engaging elements (220L and 220R), perforated spindle valves (230L and 230R), spring catches (235L, 235R) and pushrod guides (240L, 240R) It also depicts the cross section of engaging elements 220L, 220R inclusive of dampening holes 221L, 224L, 221R and 224R in the reciprocating fluid meter 001 of FIG. 1a.

FIG. 3d is a horizontal cross-sectional view (along line B-B in FIG. 3b). The pushrod (210) comprises an elongated member having a bore (FIG. 3c 211L, 211R) on each end.

Engaging elements (220L and 220R), perforated spindle valves (230L and 230R), and spring catches (235L and 235R) are rigidly coupled to pushrod 210. In preferred embodiments, the engaging elements (220L and 220R) have through holes (221-226) that can be plugged or unplugged to adjust the damping force.

FIG. 3g is an exploded view of endcap 300R showing pushrod guide 240R separated longitudinally along the extended center-line of endcap 300R, with bolts (237R, 238R, 239R) displaced laterally about the center-line of endcap 300R. Bolts (237R, 238R, 239R) affix 240R to 300R.

FIG. 3h is a perspective view of assembled endcap 300R depicting 240R rigidly mounted inside of endcap 300R.

FIG. 4a is a multi-angle sectional view of endcap 300 in the reciprocating fluid meter 001 of FIG. 1a. Each endcap contains two ports, one inlet (310, 320) and one outlet (330, 340).

FIG. 4b is a view from the cylinder housing side of the right end-cap 300R in the reciprocating fluid meter 001 of FIG. 1a. The endcap (300R) has inlet 310 and outlet 330. Six channels (301R-306R) lead from the center of the valve (FIG. 5b 326) inside endcap 300R to chamber 528, inside the cylinder, between the piston and the inner face of each endcap.

Two tapered pins (FIG. 5c, 5d, 307L, 307R) protrude from the inner face of each endcap (300L, 300R). Each tapered pin fits directly into a similar size hole (FIG. 5c, 5d, 308L, 308R) in the piston (260). The pin insures that the piston stays in longitudinal alignment and does not rotate about the axis of pushrod 210 while in motion.

FIG. 5a is a perspective cross-sectional view of the reciprocating fluid meter 001 of FIG. 1a, along line A-A of the right end-cap in FIG. 4b showing two channels in each end-cap. FIG. 5b is a side cross-sectional view of the reciprocating fluid meter 001 of FIG. 1a, along line A-A of the right end-cap in FIG. 4b showing two channels in each end-cap. Channels 302L and 305L are visible in left end-cap 300L. Channels 302R and 305R are visible in right end-cap 300R.

FIG. 5c is a perspective view of a cross section of the reciprocating fluid meter 001 of FIG. 1a, along line B-B of the right end-cap showing two channels in each end-cap. FIG. 5d is a side cross-sectional view of the reciprocating fluid meter 001 of FIG. 1a, along line B-B of the right end-cap showing two channels in each end-cap. Channels 301L and 306L are visible in left end-cap 300L. Channels 301R and 306R are visible in right end-cap 300R.

FIG. 5e is a perspective cross-sectional view of the reciprocating fluid meter 001 of FIG. 1a, along line D-C (in FIG. 4b) of the right end-cap and line C-D (in FIG. 4b) of the left side, showing a portion of the first and third passages. (Note that the orientation of FIG. 4b differs from that of FIGS. 5c, d, e and f). FIG. 5f is a side cross-sectional view of the reciprocating fluid meter 001 of FIG. 1a, along line C-D (in FIG. 4b) of the left end-cap 300L, showing a portion of the first and third passages, and along line D-C (in FIG. 4b) of the right end-cap 300R showing a portion of second and fourth passages. The first passage comprises inlet 320 and channels 301L-306L (304L visible) in the left end-cap 300L. The third passage comprises outlet 330 and channels 301R-306R (303R visible).

FIG. 6a is an outside perspective view of the right sealing member 400R in the reciprocating fluid meter 001 of FIG. 1a. The sealing member (400L, 400R), which includes damping pin 410L and 410R, serve to dampen the movement of pushrod assembly 200 at the end of its travel length. This damping action slows the pushrod in its final phase of travel, preventing damage to the unit due to repeated high velocity contact between parts 220L and 220R (FIG. 7a-b) and surface 453L and 453R (FIG. 6C). In addition to damping the pushrods movement, each sealing member houses a magnet (420L, 420R) along with various components to secure the magnet into position.

FIG. 6b is an inside perspective view of the right sealing member (400R) in FIG. 6a, comprising a shell (450R), a damping pin (410R), a magnet (420R), and a washer (430R).

FIG. 6c is a vertical cross-sectional view of the right sealing member (400R) along line A-A in FIG. 6b. The right sealing member (400R) comprises a shell (450R), a damping pin (410R), a magnet (420R), a washer (430R), a spring washer (441R) and a retaining ring (442R). These components mount in shell 450L, 450R around column 451L, 451R, where a retaining ring snaps into a given gland that can be seen in FIG. 6C. In preferred embodiments, sealing member (400R) comprises a receptacle or chamber (454R), with either tapered or straight walls.

Damping pin 410L, 410R in FIG. 6c contains 4 (or more) O-rings. 3 O-rings (412 L, 412R), which are mounted in the three O-ring glands closest to the threaded shoulder of damping pin 410L and 410R, serve to seal the damping pin, preventing pressurized fluid from escaping the device. One or more O-rings (415L, 415R), are mounted in one or more O-ring glands closest to the tapered end of the damping pin (410L, 410R), serve to pressurize each bore (ref. FIG. 7a 211L, 211R) at the end of the pushrod (210).

FIG. 6d is a vertical cross-sectional view of sealing member 400R along line B-B in FIG. 6c, showing the right sealing member (400R) comprising the shell (450R), a damping pin (410R), a magnet (420R) and the central column (451R) of shell 450R.

FIG. 6e is a vertical cross-sectional view of sealing member (400R) along line C-C in FIG. 6c, showing the right sealing member (400R) comprising a shell (450R), a damping pin (410R), and a washer (430R).

FIG. 6f is a perspective view and cross-sectional views along lines D-D and E-E of the right sealing member shell (450R) of the reciprocating fluid meter 001 of FIG. 1a. FIG. 6g is a cross-sectional side view along line D-D in FIG. 6f. FIG. 6h is a cross-sectional side view along line E-E in FIG. 6f. Depicted in FIG. 6h, detail 452R is a thru hole. This hole allows a spanner wrench to tighten and loosen the sealing member (400L, 400R) inside of its respective endcap (300L, 300R).

FIG. 7a is a side cross-sectional view of the right sealing member 400R along line A-A in FIG. 6b, interacting with the pushrod 210 in the reciprocating fluid meter 001 of FIG. 1a of the primary embodiment. The right engaging element 220R is in contact with the right sealing member 400R. The magnet 420R can interact with the right engaging element 220R. Washer 430R is seated directly against magnet 420R and serves to shield the magnet. The damping pin 410R is inside the bore 211R of the pushrod 210.

FIG. 7b is a perspective cross-sectional view of the right sealing member 400R along line A-A in FIG. 6b, interacting with the pushrod 210 in the reciprocating fluid meter 100 of FIG. 1a. The engaging element 220R contains a plethora of through tapped holes surrounding the center of the part (ref. FIG. 7c), 3 of which are visible in FIG. 7b. (221R, 222R, and 226R), where thru hole 226R is being blocked by a bolt 466R.

The engaging element 220R enters chamber 454R (FIG. 6c) of sealing member 400R and exerts pressure on the fluid trapped between the face of 220R and surface 453R. Pushrod assembly 200 slows to an acceptable velocity in accordance with the pressure exerted on the trapped fluid. The trapped fluid can exit chamber 454R in three ways: 1) around the sides of chamber 454R, between the OD of 220R and the chamber walls of 454 (prior to O-ring 444R FIG. 7a, engaging the OD of 220R), 2) through the holes in engaging element 220R FIG. 7b, which can be individually blocked by screws (466R), and 3) through the thru-hole 212R (FIG. 7b) inside of bore 211R. It is contemplated that chamber 454R and 454L have tapered or straight walls.

It is contemplated that as engaging element 220R approaches the magnet inside sealing member 400R, the force exerted on the fluid trapped in chamber 454R increases. In the primary embodiment, chamber 454R and 454L are tapered, therefore as the engaging element 220R travels closer to magnet 420R, the O-ring (444R) which is mounted on the bore of chamber 454 eventually makes contact with the OD of engaging element 220R. This forces more fluid to move through the plethora of holes (221R-226R) of engaging element 220R, and stopping the flow of fluid around engaging element (220R), further slowing pushrod assembly 200.

When pushrod assembly 200 is in transition, damping pin 410R, FIG. 7a, engages and enters the orifice at the end of pushrod 210, and simultaneously exits the orifice at the opposite end of pushrod 210.

It is contemplated that damping pin 410R and 410L is tapered, which gradually increases the pressure trapped inside of bore 211R at the end of pushrod 210 (ref FIG. 7a). It is further contemplated that when pushrod 210 reaches O-ring 412R while in transition, the pressure inside of bore 211R will increase.

In preferred embodiments, a small diameter thru-hole (FIG. 7a 212R) connects bore 211R with the outflow side of endcap 300R. This small diameter thru-hole relieves pressure inside of bore 211R. The rate at which fluid exits the bore through thru-hole 212 is largely dependent upon the viscosity of the media being metered by the device. To compensate for this, the amount of fluid under pressure inside of bore 211R can be adjusted by rotating damping pin 410 about its longitudinal axis through its threaded shoulder (411).

In conjunction with the depth sitting of damping pin 410R, the pushrod (210), while in transition to its new seated position, will reach O-ring 412R, trapping the remaining fluid inside bore 211R, and forcing it to exit through thru-hole 212R. The point at which O-ring 412R seals bore 211R is dependent upon the position of the damping pin, as adjusted by the rotation of its threaded base.

FIG. 7c is an exploded cross sectional view of the right sealing member (400R) of the primary embodiment. The components included in sealing member 400R, are the sealing member shell (450R), a magnet (420R), a washer (430R) and a damping pin (410R). Ancillary parts included in the assembly are O-ring 446R, which seals sealing member 400R inside of endcap 300R, O-ring 444R, which is mounted in the bore of chamber 454R, and seals the chamber when the pushrod is in transition, washer 443, a spring washer (441R), and a retaining ring (442R) which holds parts 420, 430, 443 and 441 inside of shell 450.

FIG. 8a is an exploded view of the encoder/display housing (500) in the reciprocating fluid meter 001 of FIG. 1a. The encoder/display housing (FIGS. 8a, 8b and 8c) is synonymous with both primary embodiment and alternate embodiment (A).

FIG. 8b is an exploded perspective view of the encoder (500), less the display housing, in alignment with piston 260 in the reciprocating fluid meter 001 of FIG. 1a. This view shows how small magnets inside the piston, and magnets outside of the cylinder housing (150) align and serve to track piston 260. Embedded into the circumference of piston 260, displaced left and right of the pistons lateral center, are a series of magnets (FIG. 8b, 8c, 261, 262). When piston 260 is in motion along its longitudinal track inside of cylinder housing (150), the position of magnets 261 and 262 is physically tracked by a series of similar magnets (263, 264) attached magnetically to one and other outside of cylinder housing 150. Magnets 263 and 264 are rigidly mounted inside encoder target housing 520. Magnets 263 and 264 move in conjunction with piston magnets 261 and 262. This action moves the linear encoder target housing (520). The linear encoder target (265) is rigidly attached to housing 520, and when in motion with piston 260, will draw the encoder target (265) across encoder board (268), producing position data relative to piston 260.

FIG. 8c is a cross-sectional view of the encoder, 500, less the display housing, in alignment with piston 260 in the reciprocating fluid meter 001 of FIG. 1a. Note the alignment of piston magnets 261 and 262, with the magnets (263, 264) contained inside of encoder target housing 520.

Piston 260 (FIG. 8c) of the primary embodiment and piston 710 (FIG. 10h) of alternate embodiment (A) are identical in their functionality with the encoder.

FIG. 9a is a partially exploded cross-sectional view of the left end-cap 300L and sealing member 400L in the primary embodiment of the reciprocating fluid meter 001 of FIG. 1a. Engaging element 220L is disengaged from sealing member 400L, and damping pin 410L is disengaged with bore 211L of pushrod 210. Note the position of perforated spindle valve 230L in a first position, outlet port 340 is open, allowing fluid to exit the device, and inlet port 320 is closed. Fluid is entering endcap 300L internally through ports 301L, 302L, 303L, 304L, 305L and 306L (304L is visible, reference FIG. 4b). Flowing through the plethora of holes in perforated spindle valve 230L, and exiting the device from outlet 340. Draining chamber 525, on the opposite side, chamber 528 is flooding.

FIG. 9b is a partially exploded cross-sectional view of left end-cap 300L and sealing member 400L in the primary embodiment of the reciprocating fluid meter 001 of FIG. 1a, with the engaging element 220L entering chamber 454L of sealing member 400L. Pushrod assembly 200 is in transition to its engaged position inside of chamber 454L in sealing element 400L, and is half-way across its movement track. Note the position of perforated spindle valve 230L in a second position, blocking flow to both inlet port 320 and outlet port 340. Damping pin 410L is half-way engaged with bore 211L of pushrod 210.

FIG. 9c is a partially exploded cross-sectional view of left end-cap 300L and sealing member 400L in the primary embodiment of the reciprocating fluid meter 001 of FIG. 1a, with engaging element 220L mated with sealing member 400L, and the damping pin 410L fully engaged with tapered bore 211L of pushrod 210. Note the position of perforated spindle valve 230L in a third position, outlet port 340 is closed, and inlet port 320 is open. Fluid is entering the device through inlet port 320, flowing through the plethora of holes in perforated spindle valve 230L, and exiting the device internally through ports 301L, 302L, 303L, 304L, 305L and 306L (304L is visible, reference FIG. 4b) flooding chamber 525. On the opposite side, chamber 528 is draining.

FIG. 10a-g shows piston 260 moving longitudinally inside cylinder housing 150 to the left, reversing direction, and moving to the right, in conjunction with fluid flowing through the invention. FIGS. 10a-10g pertain to the primary embodiment only. FIG. 10a-c show piston 260 in different positions as it moves right to left. FIG. 10a is a cross-sectional view of the reciprocating fluid meter 001 of FIG. 1a, along line C-C in FIG. 4b, depicting pushrod assembly 200 in a position where the first passage (between inlet 310 and first chamber 528) is open, the third passage (between first chamber 528 and first outlet 330) is closed, the second passage (between second inlet 320 and second chamber 525) is closed, the fourth passage (between second chamber 525 and second outlet 340) is open. Fluid flows into right chamber 528 through the first passage (comprising inlet 310), pushing piston 260 toward the left. The fluid in the left chamber, 525 exits through the fourth passage (comprising outlet 340). The right engaging element 220R is coupled with magnet 420R in the right sealing member (400R), and the left engaging element 220L is decoupled with the magnet 420L in conjunction with the left sealing member, (400L).

FIG. 10b is a cross-sectional view of the reciprocating fluid meter 001 of FIG. 1a, along line C-C in FIG. 4b, showing the pushrod assembly 200 in the same position as in FIG. 10a. FIG. 10b shows piston 260 has traveled further to the left, and spring 250L has made contact with the internal base of spring catch 235L. As the piston continues to travel left, spring 250L compresses between spring catch 235L and piston 260, producing an elastic force that is passed through to pushrod assembly 200. In opposition to this force, magnet 420R is coupled with engaging element 220R, counteracting the elastic force generated by spring 250L, and the pushrod remains static.

FIG. 10c is a cross-sectional view of the reciprocating fluid meter 001 of FIG. 1a, along line C-C in FIG. 4b, showing pushrod assembly 200 in the same position as in FIG. 10a. Piston 260 has made physical contact with spring catch 235L at point 241 between the small diameter face of spring catch 235L (surface 245, FIG. 3c, FIG. 9a) and the inner face of piston 260, inside the ID of spring 250 (surface 315, FIG. 5a). In this position, spring 250L is compressed to its target length and has enough potential energy to physically move pushrod assembly 200 to its new seated position against magnet 420L. The contact at point 241 between piston 260 and spring catch 235L, pushes spring catch 235L further left, along with pushrod assembly 200. Once the right engaging element 220R breaks contact with surface 453R (ref FIG. 6c) inside of sealing member 400R, the magnetic force decreases allowing compressed spring 250L to release its stored energy and drive pushrod assembly 200 to its new seated position inside of the opposite sealing member (400L).

FIG. 10d is a cross-sectional view of the reciprocating fluid meter 001 of FIG. 1a, along line C-C in FIG. 4b, showing the pushrod assembly 200 in a second transitional position. Note that in this position, pushrod assembly 200 is in motion. Magnetic element 220R is decoupled from magnet 420R and is being driven toward its new seated position against magnet 420L by the force produced by compressed spring 250L. At this position, pushrod assembly 200 is half way through its motion to the opposite magnet. The perforated spindle valves (230L and 230R) momentarily close all passages, including the first passage (between inlet 310 and first chamber 528), the second passage (between second inlet 320 and second chamber 525), the third passage (between first chamber 528 and first outlet 330), and the fourth passage (between second chamber 525 and second outlet 340). In this position engaging element 220L and 220R are disengaged from both 420L and 420R. The pushrod assembly 200 is moving left, due to the elastic force exerted by spring 250L on spring catch 235L. Piston 260 is momentarily stopped and will reverse its direction and begin to travel to the right as soon as inlet 320 opens and outlet 330 opens, inlet 310 and outlet 340 will remain closed.

FIG. 10 e-g shows piston 260 in different positions as it moves left to right. FIG. 10e is a cross-sectional view of the reciprocating fluid meter of FIG. 1a, along line C-C in FIG. 4b, showing pushrod assembly 200 in a third position, where the first passage (between inlet 310 and first chamber 528) is closed, the second passage (between second inlet 320 and second chamber 525) is open, the third passage (between first chamber 528 and first outlet 330) is open, the fourth passage (between second chamber 525 and second outlet 340) is closed. The right engaging element 220R is decoupled with the magnet 420R. The left engaging element 220L is coupled with magnet 420L. Piston 260 is disposed on the left side and is moving towards the right side.

FIG. 10f is a cross-sectional view of the reciprocating fluid meter 001 of FIG. 1a, along line C-C in FIG. 4b, showing the pushrod assembly 200 in the third position as in FIG. 10e, showing the piston 260 is disposed just left of the center position and is moving towards the right.

FIG. 10g is a cross-sectional view of the reciprocating fluid meter 001 of FIG. 1a, along line C-C in FIG. 4b, showing pushrod assembly 200 in the third position as in FIG. 10e. Piston 260 is disposed right of center, compressing spring 250R between piston 260 and the internal base of spring catch 235R. When piston 260 contacts spring catch 235R, it will force engaging element 220L to decouple from magnet 420L, allowing spring 250R to drive pushrod assembly 200 to its new seated position against magnet 420R. This will complete the reversal process. Piston 260 then moves in the opposite direction, and the process repeats.

### Alternate Embodiment (A) Detailed Description

FIG. 2c is an exploded perspective view of alternate embodiment (A) of the reciprocating fluid meter of FIG. 1d, without the display interface (501). This view calls out the specific parts which differ from the primary spring/magnet embodiment.

In alternate embodiment (A), pushrod 706 comprises an elongated member that can travel inside housing 150.

In alternate embodiment (A) the components which are rigidly attached to pushrod 706, or move along the longitudinal centerline of the pushrod can be seen in FIG. 2c and FIG. 3e. Piston 710 floats freely inside housing 150, and travels along the length of the pushrod. Both the ID and the OD of piston 710 are sealed against the ID of the cylinder (150) and the OD of the pushrod (706). This prevents fluid from leaking to the opposite side of the piston, which would degrade the meters accuracy.

Adjacent to either side of piston 710, mounted on pushrod 706 is pushrod guide 704L and 704R (FIG. 2c, 3e, 3f). Each pushrod guide is rigidly attached to endcaps 300L and 300R (FIG. 3i). Pushrod guides 704L and R serve to seal chambers 525 and 528 (FIG. 5h) from each valve assembly inside endcaps 300L and 300R.

Perforated spindle valves 702L and 702R, are each rigidly attached to pushrod 706. Unlike the primary embodiment, these are the only parts which are affixed to pushrod 706. Perforated spindle valves 702L and 702 R of alternate embodiment (A) are slightly wider than perforated spindle valves 230L and 230R of the primary embodiment.

The perforated spindle valves of alternate embodiment (A) serve two purposes.
1) (Reference FIG. 3j) perforated spindle valves 702L and 702R, rigidly attached to pushrod 706 can start and stop the flow of media traveling through the invention by halting their movement half way through the travel length (note the position of 702L and 702R blocking both the inflow and outflow passages in either endcap at the same time), this is the second position. This is accomplished by the 3 position air cylinder or linear motor (712, FIGS. 3e and j) driving pushrod assembly 750 (FIG. 3k), which can stop in the center position depicted in FIG. 3j.
Because the position of pushrod assembly 750 (FIG. 3k) can start and stop the flow of media, the external valve (205, FIG. 1a, 1b) associated with the primary embodiment is not necessary in alternate embodiment (A), and as such, has been eliminated.
2) Perforated spindle valves 702L and 702R, serve to guide the flow of media through the device, shifting positions at the end of piston 710's travel length between a first (FIG. 10h) and third (FIG. 10j) position, thus reversing the internal flow of media, causing the piston to reverse direction and repeat this reciprocating motion.

Sealing member 700L and 700R (FIG. 3e), mounted rigidly to the end of endcaps 300L and 300R (FIG. 2c), serve to seal each endcap, guide pushrod 706, and serve as mounting point for air cylinder/motor 712.

4 standoffs (714, FIG. 3e-f) mount directly to sealing member 700R, and mounting block 708 (FIG. 3e-f). Air cylinder/motor 712 is affixed to mounting block 708, while the air cylinder/motor shaft screws directly into pushrod 706 (reference FIG. 3e-f).

FIG. 3i is a left side view of endcap 300R, depicting pushrod guide 704R fully seated and affixed in place by fasteners 237, 238 and 239.

FIG. 3j is a perspective cross-sectional view of alternate embodiment (A) of FIG. 1d. FIG. 3j depicts perforated spindle valves 702L and 702R, which are rigidly attached to pushrod 706, which is driven by, and rigidly attached to the central drive shaft of air cylinder/motor 712. The pushrod assembly, consisting of pushrod 706 and perforated spindle valves 702R and 702L, are in a second position (Ref FIGS. 3j and 10i). In this position, the flow of media flowing through the device has stopped, as both the inflow and outflow passages of each endcap is blocked by perforated spindle valves 702L and 702R. This internal valve position serves to control the flow of fluid moving through the device, allowing the invention to stop the flow of fluid at specified volumes or masses, as programmed by the end user of the invention.

FIG. 3k is a perspective view of alternate embodiment (A) pushrod assembly. It includes pushrod 706 and rigidly attached perforated spindle valves 702L and 702R.

FIG. 5g is a perspective cross-sectional view of alternate embodiment (A) fluid meter 002 of FIG. 1d, along line D-C (in FIG. 4b) of the right end-cap and line C-D (in FIG. 4b) of the left side, showing a portion of the first and third passages. (Note the orientation of FIG. 4b differs from the orientation of FIG. 5g).

FIG. 5h is a side cross-sectional view of alternate embodiment (A) reciprocating fluid meter 002 of FIG. 1d, along line B-B of the right end-cap showing two channels in each end-cap. Channels 301L and 306L are visible in left end-cap 300L. Channels 301R and 306R are visible in right end-cap 300R.

FIG. 9d is a partially exploded cross-sectional view of right end-cap 300R in alternate embodiment (A) of the reciprocating fluid meter 002 of FIG. 1d. Note position of perforated spindle valve 702R in a first position. Outlet port 330 is open, allowing fluid to exit the device, and inlet port 310 is closed. Fluid is entering endcap 300R internally through ports 301R, 302R, 303R, 304R, 305R and 306R (304R is visible, reference FIG. 4b). Flowing through the plethora of holes in perforated spindle valve 702R, and exiting the device from outlet 330. Draining chamber 525 (not shown), on the opposite side, chamber 528 is flooding.

FIG. 9e is a partially exploded cross-sectional view of right end-cap 300R in alternate embodiment (A) of the reciprocating fluid meter 002 of FIG. 1d. Note position of perforated spindle valve 702R in a second (centered) position, blocking flow to both inlet port 310 and outlet port 330.

FIG. 9f is a partially exploded cross-sectional view of right end-cap 300R in alternate embodiment (A) of the reciprocating fluid meter 002 of FIG. 1d. Note the position of perforated spindle valve 702R in a third position, outlet port 330 is closed, and inlet port 310 is open. Fluid is entering the device through inlet port 310, flowing through the plethora of holes in perforated spindle valve 702R, and exiting the device internally through ports 301L, 302L, 303L, 304L, 305L and 306L (304L is visible, reference FIG. 4b) flooding chamber 525 (not visible). On the opposite side, chamber 528 is draining.

FIG. 10h shows piston 710 moving longitudinally inside cylinder housing 150 from right to left, in conjunction with fluid flowing through the invention. Note pushrod assembly 750 (FIG. 3k) in a first position, as defined by paragraph [0088].

FIG. 10h is a cross-sectional view of the alternate embodiment reciprocating fluid meter 002 of FIG. 1d, along line C-C in FIG. 4b, depicting pushrod assembly 750 (FIG. 3k) in a first position where the first passage (between inlet 310 and first chamber 528) is open, the third passage (between first chamber 528 and first outlet 330) is closed, the second passage (between second inlet 320 and second chamber 525) is closed, the fourth passage (between second chamber 525 and second outlet 340) is open. Fluid flows into right chamber 528 through the first passage (comprising inlet 310), pushing piston 710 toward the left. The fluid in the left chamber, 525 exits through the fourth passage (comprising outlet 340).

As piston 710 moves left (FIG. 10h), its position is tracked through the movement of linear encoder target 520. When piston 710 reaches the end of its travel length, the position of piston 710 will be relayed to the RPM computer via linear encoder target 520. The RPM computer will then command air cylinder/motor 712 to shift from its present first position, through a second position (FIG. 10i), directly to a third position (FIG. 10j). In this third position, the media flow will reverse, and the piston will shift direction.

FIG. 10i shows piston 710 at its full left travel length inside cylinder housing 150. Note pushrod assembly 750 (FIG. 3k) in a second position, as defined by paragraph [0089].

FIG. 10i is a cross-sectional view of alternate embodiment (A) reciprocating fluid meter of FIG. 1d, Along line C-C in FIG. 4b, showing the pushrod assembly (750 FIG. 3k.) in a second position, where the first passage (310) (between first inlet and first chamber 528) is closed, the second passage (320) (between second inlet and second chamber 525) is closed, the third passage (330) (between first chamber 528 and first outlet) is closed, the fourth passage (340) (between second chamber 525 and second outlet) is closed.

FIG. 10i depicts piston 710 at the end of its left travel length inside cylinder housing 150, and shows pushrod assembly 750 (FIG. 3k) in a second position in transition to a third position. Linear encoder target 520 has relayed the position of piston 710 to the RPM computer and signaled air cylinder/motor 712 to transition to a third position.

FIG. 10j shows piston 710 moving longitudinally inside cylinder housing 150 from left to right, in conjunction with fluid flowing through the invention. Note pushrod assembly 750 (FIG. 3k) in a third position, as defined by paragraph [0090].

FIG. 10j is a cross-sectional view of alternate embodiment (A) reciprocating fluid meter of FIG. 1d, Along line C-C in FIG. 4b, showing the pushrod assembly (750 FIG. 3k) in a third position, where the first passage (310) (between first inlet and first chamber 528) is closed, the second passage (320) (between second inlet and second chamber 525) is open, the third passage (330) (between first chamber 528 and first outlet) is open, the fourth passage (340) (between second chamber 525 and second outlet) is closed.

FIG. 10j depicts alternate embodiment (A) with pushrod assembly 750 (FIG. 3k) in a third position. In this position fluid is moving through the device, displacing piston 710 from left to right. When piston 710 reaches the end of its travel length, the position of the piston will be relayed to the RPM computer via linear encoder target 520. The RPM computer will then command air cylinder/motor 712 to shift from its present third position, through a second position (FIG. 10i), directly to a first position (FIG. 10h) and the sequence will repeat.

### Alternate Embodiment (B) Detailed Description

Alternate embodiment (B) is a highly accurate piston pump. It combines the accuracy of the primary embodiment or alternate embodiment (A), with the force and precision of a linear actuator. Alternate embodiment (B) can start, stop and alter rate of flow, making it highly useful in a wide range of industrial applications.

Alternate embodiment (B) FIG. 1e depicts a subassembly or framework which is built as part of the primary embodiment (FIG. 1a), or alternate embodiment (A) (FIG. 1d).

Alternate embodiment (B) incorporates a stepper motor (FIG. 1e, 804) a linear screw (FIG. 1e 800) and a gear box (FIG. 1e 806). These components attach directly through the linear actuators driveshaft (802) to coupling 840 (FIG. 1e) and driveshaft's 842 and 844 (FIG. 1e). Driveshaft's 842 and 844 are rigidly attached to piston 846 (FIG. 2f, FIG. 2h) of the primary embodiment or alternate embodiment (A) and run through endcap 880 (FIG. 1e).

These components are encapsulated inside a framework which allows the transmission of force to piston 846 of the primary embodiment or alternate embodiment (A). Piston 846, (FIG. 2f, 2h) moves back and forth along the same track, over the same distance as the primary or alternate embodiment (A). The starting, stopping points and rate of travel can be precisely controlled through stepper motor 804, via the user interface.

The stepper motor (804) of alternate embodiment (B) drives piston 846 along the longitudinal centerline of cylinder 150 (FIG. 2a). In the primary embodiment, when piston 846 approaches the end of its travel length, the stepper motor will ramp down until valves in endcaps 880 and 300R (FIGS. 2d and 2c) shift position, the linear encoder (265, 268 FIG. 8b) will then signal the RPM computer to drive the stepper motor in the opposite direction, reversing the direction of the piston.

The stepper motor (804) of alternate embodiment (B) drives piston 846 along the longitudinal centerline of cylinder 150 (FIG. 2a). In alternate embodiment (A), when piston 846 approaches the end of its travel length, the RPM computer will detect the position of the piston via the linear encoder, and signal the pneumatic air cylinder or motor (712, FIG. 2c) to shift valve positions inside endcaps 880 and 300R (FIGS. 2d and 2c), at the same time the RPM computer will signal stepper motor 804 to reverse direction, driving the piston in the opposite direction.

Assembly of alternate embodiment (B) consists of 3 subassemblies.

Subassembly 1—The fully assembled linear actuator is comprised of linear screw 800, stepper motor 804, and gear box 806. Two rectangular steel plates (820, 822 FIG. 2g) are pinned (866, 868 FIG. 2g) to each side of the linear actuator. Mounting blocks 834, 824 and 826 are bolted to the linear actuator, then plates 820 and 822 are bolted to mounting blocks 834, 824 and 826. Coupling 840 is bolted to linear actuator driveshaft 802.

Subassembly 2—Six mounting feet (874) are bolted to the base plate (832) of alternate embodiment (B).

Subassembly 3—Driveshaft's 842 and 844 are bolted to piston 846. The opposite end of driveshaft's 842 and 844 slide longitudinally through sealed holes in endcap 880. Piston 846 slides inside of cylinder 150 of the primary embodiment or alternate embodiment (A). The assembly process for either the primary embodiment or alternate embodiment (A) is then completed, ending with mounting plates 828 and 830 (FIG. 2g) being bolted to each other via tie rods 876. Note driveshaft's 842 and 844 are now protruding out of endcap 880 of subassembly 3.

Mounting plates 820 and 822 of subassembly 1 are bolted to the primary mounting plate (832) of subassembly 2.

Subassembly 3 is placed on the primary mounting plate of subassembly 2. Driveshaft's 842 and 844 are bolted (870) into coupling 840. Mounting plates 828 and 830 are bolted to primary mounting plate 832. Mounting plates 820 and 822 are bolted (872) to mounting plate 828.

Communication wiring is run between the servo driver and the RPM computer. Assembly complete.

### In Summary

To summarize the primary embodiment, when piston 260 reaches its full length of travel, pushrod assembly 200, which is rigidly attached to perforated spindle valves 230L and 230R, shifts its position which causes the fluid to reverse direction, and in turn, piston 260 also reverses its direction. The movement of the encoder target housing (520) is an indication of the volumetric flow rate of fluid flowing through the invention. Flow rate is determined by tracking the position of piston 260 in conjunction with time (a function of the RPM computer 515), as it moves back and forth inside cylinder 150. The reciprocating fluid meter 001 is highly precise as it is a 100% positive displacement mechanism, it is physically impossible for fluid to pass through the meter without displacing the piston.

Alternate embodiment (A) differs from the primary embodiment in that pushrod assembly 200 (FIG. 3b) of the primary embodiment is powered by a spring working in conjunction with a magnet. The spring is loaded through fluid pressure. Alternate embodiment (A) uses a motor or air cylinder to power pushrod assembly 750 (FIG. 3k). Alternate embodiment (A) shifts the position of pushrod assembly 750 with positional input of the piston via the linear encoder and RPM computer. The primary embodiment shifts pushrod assembly mechanically.

Alternate embodiment (B) incorporates the force and precision of a linear actuator to drive the piston of the primary embodiment, or alternate embodiment (A). The result is a very accurate pump capable of controlling rates of flow, along with starting and stopping flow. The RPM pump, or alternate embodiment (B) is a standalone unit, capable of delivering exact amounts of fluid product in the fields of compounding, dosing, batching, custody transfer and product transfer.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A reciprocating fluid meter assembly for measuring a flow rate or a volume of a fluid, comprising:
a housing having first and second chambers;
a first inlet and a first outlet;
a second inlet and a second outlet;
first and second passages that couple the first and second inlets to the first and second chambers, respectively;
third and fourth passages that couple the first and second outlets to the first and second chambers, respectively;
a pushrod comprising an elongated member slidably disposed inside the housing and transitionable between a first position and a second position;
a piston coupled with the pushrod and sized and dimensioned to fluidly decouple the first chamber from the second chamber;
a tracking device that is capable of tracking a position of the piston;
a first valve positioned at a first junction between the first and third passages;
a second valve positioned at a second junction between the second and fourth passages;
wherein the first and second valves are rigidly coupled with the pushrod and disposed on opposing sides of the piston;
a first engaging element and a second engaging element rigidly coupled to the pushrod and disposed on opposing sides of the piston, wherein the first and second engaging elements comprise a magnetically attractable material;
a first magnet located outside the first engaging element; and
a second magnet located outside the second engaging element.

2. The reciprocating fluid meter assembly of claim 1, further comprising:
a first spring and a second spring disposed on the pushrod and on opposing sides of the piston; and
a first spring catch and a second spring catch rigidly coupled with the pushrod and disposed outside of the first and second springs, respectively;
wherein when the pushrod is in the first position, a first magnetic force coupling the first engaging element and the first magnet is sufficient to counteract the second spring; and when the pushrod is in the second position, a second magnetic force coupling the second engaging element and the second magnet is sufficient to counteract the first spring.

3. The reciprocating fluid meter assembly of claim 1, further comprising a first sealing member and a second sealing member that are sized and dimensioned to seal the pushrod within the housing.

4. The reciprocating fluid meter assembly of claim 3, further comprising a driver mounted to one of the first and second sealing members for controlling a position of the pushrod.

5. The reciprocating fluid meter assembly of claim 4, wherein the driver comprises an air cylinder or a motor having a shaft, wherein the shaft is rigidly coupled with the pushrod.

6. The reciprocating fluid meter assembly of claim 4, wherein the driver is communicatively coupled with a computer.

7. The reciprocating fluid meter assembly of claim 6, wherein the computer is communicatively coupled with a linear encoder for monitoring a position of the piston.

8. The reciprocating fluid meter assembly of claim 7, wherein the computer is configured to actuate the driver and change a position of the pushrod based on a signal from the linear encoder.

9. The reciprocating fluid meter assembly of claim 7, wherein the driver is configured to shift the pushrod between a first position, a second position, and a third position, wherein:
in the first position, the first valve is positioned such that the first chamber is fluidly coupled with the first inlet and fluidly decoupled with the first outlet, and the second valve is positioned such that the second chamber is fluidly coupled with the second outlet and fluidly decoupled with the second inlet; and
in the second position, the first chamber is fluidly decoupled from the first inlet and the first outlet, and the second chamber is fluidly decoupled with the second inlet and second outlet; and
in a third position, the second valve is positioned such that the second chamber is fluidly coupled with second inlet and fluidly decoupled with the second outlet, and the first valve is positioned such that the first chamber is fluidly coupled with the first outlet and fluidly decoupled with the first inlet.

10. The reciprocating fluid meter assembly of claim 1, wherein:
the first engaging element has a first plurality of through holes; and
the second engaging element has a second plurality of through holes.

11. The reciprocating fluid meter assembly of claim 1, wherein the first engaging element and second engaging element each have a tapered outer wall.

12. The reciprocating fluid meter assembly of claim 11, wherein:
the first sealing member has a first tapered hole that is sized and dimensioned to receive the tapered outer wall of the first engaging element; and
the second sealing member has a second tapered hole that is sized and dimensioned to receive the tapered outer wall of the second engaging element.

13. The reciprocating fluid meter assembly of claim 1, further comprising a primary valve for controlling flow of a fluid exiting the reciprocating fluid meter assembly, wherein the primary valve is programmed to open and close based on an output of the tracking device.

14. The reciprocating fluid meter assembly of claim 1, wherein the piston has at least one magnet and the tracking device has at least one magnet positioned to magnetically couple with the magnet of the piston.

15. The reciprocating fluid meter assembly of claim 1, wherein:
in the first position, the first valve is positioned such that the first chamber is fluidly coupled with the first inlet and fluidly decoupled with the first outlet, and the second valve is positioned such that the second chamber is fluidly coupled with the second outlet and fluidly decoupled with the second inlet; and
in the second position, the first chamber is fluidly decoupled from the first inlet and the first outlet, and the second chamber is fluidly decoupled with the second inlet and second outlet; and
in a third position, the second valve is positioned such that the second chamber is fluidly coupled with second inlet and fluidly decoupled with the second outlet, and the first valve is positioned such that the first chamber is fluidly coupled with the first outlet and fluidly decoupled with the first inlet.

16. The reciprocating fluid meter assembly of claim 5, wherein the magnetic attraction between the first engaging element and the first magnet is sufficient to counteract the elastic force produced by the second spring, and the magnetic attraction between the second engaging element and second magnet is sufficient to counteract the elastic force produced by the first spring.

17. A reciprocating fluid meter assembly for measuring a flow rate or a volume of a fluid, comprising:
a pushrod having a first end and a second end;
a first sealing member having a first receptacle and a second sealing member having a second receptacle, wherein the first sealing member and second sealing member are located outside of the first end and the second end of the pushrod, respectively;
a first engaging element and a second engaging element rigidly coupled near the first end and the second end of the pushrod, respectively; wherein the first and second engaging elements are sized and dimensioned to mate with the first and second receptacles of the sealing member, respectively;
wherein the first receptacle has a tapered inner diameter sized and dimensioned to receive the first engaging element; and
wherein the second receptacle has a tapered inner diameter that is sized and dimensioned to receive the second engaging element.

18. The reciprocating fluid meter assembly of claim 17, further comprising a first magnet and a second magnet coupled to the first sealing member and the second sealing member, respectively; wherein the first and second engaging elements comprises a magnetically attractable material.

19. The reciprocating fluid meter assembly of claim 17, further comprising a driver coupled with one of the first and second sealing members for controlling a position of the pushrod.

20. The reciprocating fluid meter assembly of claim 17, wherein the mating between the first and the second engaging elements and the first and the second receptacles of the sealing members, respectively, can at least partially reduce a travelling speed of the pushrod.

21. A reciprocating fluid meter assembly for measuring a flow rate or a volume of a fluid, comprising:
a housing having first and second chambers;
a first inlet and a first outlet;
a second inlet and a second outlet;
first and second passages that couple the first and second inlets to the first and second chambers, respectively;
third and fourth passages that couple the first and second outlets to the first and second chambers, respectively;
a pushrod comprising an elongated member slidably disposed inside the housing and transitionable between a first position and a second position;
a piston coupled with the pushrod and sized and dimensioned to fluidly decouple the first chamber from the second chamber;
a tracking device that is capable of tracking a position of the piston;
a first valve positioned at a first junction between the first and third passages;
a second valve positioned at a second junction between the second and fourth passages;
wherein the first and second valves are rigidly coupled with the pushrod and disposed on opposing sides of the piston; and
wherein the first and second valves each comprise a cylindrical member having an outer wall surrounding an interior space, an inner wall that fluidly decouples a first portion of the interior space from a second portion of the interior space; and
wherein the outer wall of each of the first and second valves comprises a first perforation that allows fluid to flow through the first portion of the interior space, and a second perforation that allows fluid to flow through the second portion of the interior space.

22. The reciprocating fluid meter assembly of claim 21, further comprising a piston pump that is capable of controlling flow rate.

23. The reciprocating fluid meter assembly of claim 21, wherein the piston pump comprises:
a stepper motor;
a linear actuator coupled with the stepper motor; and
a driveshaft that couples the linear actuator with the piston.
